(19) United States
(12) Patent Application Publication
(10) Pub. No.: US 2014/0087136 A1
(43) Pub. Date: Mar. 27, 2014

(54) RESIN COMPOSITION AND SEMICONDUCTOR DEVICE BOARD

(71) Applicant: Yumi Osaku, Tokyo (JP)

(72) Inventor: Yumi Osaku, Tokyo (JP)

(73) Assignee: ZEON CORPORATION, Tokyo (JP)

(21) Appl. No.: 14/123,026

(22) PCT Filed: May 30, 2012
(86) PCT No.: PCT/JP2012/063839

§ 371 Date: Nov. 27, 2013

(30) Foreign Application Priority Data
Jun. 1, 2011 (JP) 2011-123090

(51) Int. Cl. H01B 3/44; C08L 45/00

(52) U.S. Cl. CPC H01B 3/448; C08L 45/00
USPC 428/141; 524/310

(57) ABSTRACT

A resin composition which contains a binder resin (A), radiation-sensitive compound (B), silane-modified resin (C), and antioxidant (D), wherein a content of the silane-modified resin (C) is 0.1 to 150 parts by weight with respect to 100 parts by weight of the binder resin (A), a content of the antioxidant (D) is 0.1 to 10 parts by weight with respect to 100 parts by weight of the binder resin (A), and an amount of warping is 14 μm or less when using the resin composition to form a thickness 2 to 3 μm resin film and baking the formed resin film at 230° C. is provided.

### TECHNICAL FIELD

The present invention relates to a resin composition and a semiconductor device board which is provided with a resin film which is comprised of this resin composition, more specifically relates to a resin composition which can give a resin film which is high in flatness and which is excellent in light resistance and heat resistance and to a semiconductor device board which is provided with a resin film which is comprised of this resin composition.

### BACKGROUND ART

Organic EL devices, liquid crystal display devices, and other various types of display devices, integrated circuit devices, solid state imaging devices, color filters, black matrixes, and other electronic devices are provided with various resin films, as protective films for preventing deterioration and scratching, flattening films for flattening the device surfaces and interconnects, or electrical insulating films for maintaining the electrical insulating property etc. Further, organic EL devices are provided with picture element separating films constituted by resin films for separating the light emitting parts. Furthermore, display devices or integrated circuit devices for thin film transistor type liquid crystal use etc. are provided with interlayer insulating films constituted by resin films for insulating the distances between interconnects which are arranged in layers.

In the past, as resin materials for forming these resin films, epoxy resins and other thermocurable resin materials have generally been used. In recent years, along with the higher densities of interconnects and devices, for these resin materials as well, development of new resin materials which are low in dielectric permittivity and excellent in other electrical characteristics is being sought.

To deal with these requests, for example, Patent Document 1 discloses a photosensitive resin composition which contains an alkali-soluble resin (A), cross-linking agent (B), and radiation-sensitive acid generator (C) and which can form an insulating film. However, the resin film which is obtained by using the resin composition which is described in this Patent Document 1 is inferior in flatness, light resistance, and heat resistance in the resin film after baking, and improvement has been sought.

### PRIOR ART DOCUMENTS

### Patent Documents

Patent Document 1: Japanese Patent Publication No. 2008-197181A

### DISCLOSURE OF THE INVENTION

### Problem to be Solved by the Invention

The present invention has as its object the provision of a resin composition which can give a resin film which is high in flatness and which is excellent in light resistance and heat resistance and a semiconductor device board which is provided with a resin film which is comprised of such a resin composition. In particular, the present invention has as its object the provision of a resin composition which can give a resin film which is high in flatness and which is excellent in light resistance and heat resistance even after baking and a semiconductor device board which is provided with a resin film which is comprised of such a resin composition.

### Means for Solving the Problems

The inventors engaged in in-depth research to achieve the above objects and as a result discovered that the above objects can be realized by a resin composition which contains a binder resin, radiation-sensitive compound, silane-modified resin, and antioxidant, and an amount of warping is to be controlled to a predetermined range when using the resin composition to form a resin film by a predetermined thickness and baking the formed resin film under predetermined conditions and thereby completed the present invention.

That is, according to the present invention, there is provided a resin composition which contains a binder resin (A), radiation-sensitive compound (B), silane-modified resin (C), and antioxidant (D), wherein a content of the silane-modified resin (C) is 0.1 to 150 parts by weight with respect to 100 parts by weight of the binder resin (A), a content of the antioxidant (D) is 0.1 to 10 parts by weight with respect to 100 parts by weight of the binder resin (A), and an amount of warping is 14 μm or less when using the resin composition to form a thickness 2 to 3 μm resin film and baking the formed resin film at 230° C.

Preferably, the content of the radiation-sensitive compound (B) is 20 to 100 parts by weight with respect to 100 parts by weight of the binder resin (A).

Preferably, the silane-modified resin (C) is a compound obtained by chemically bonding at least one polymer material selected from a polyester, polyamide, polyimide, polyamic acid, epoxy resin, acrylic resin, urethane resin, and phenol resin, and a silicon compound.

Preferably, the silicon compound is a silicon compound expressed by the following formula and/or a partially hydrolyzed condensate of a silicon compound expressed by the following formula.

(R⁸)ᵣ—Si—(OR⁹)₄₋ᵣ

(in the above formula, r is an integer of 0 to 3, R⁸ is a C₁ to C₁₀ alkyl group which may have a functional group which is directly bonded to a carbon atom, a C₆ to C₂₀ aryl group, or C₂ to C₁₀ unsaturated aliphatic group, wherein when R⁸ is a plurality of groups, the plurality of R⁸ may be the same or different. R⁹ is a hydrogen atom or C₁ to C₁₀ alkyl group which may have a functional group which is directly bonded to a carbon atom, wherein when R⁹ is a plurality of groups, the plurality of R⁹ may be the same or different.) Preferably, the binder resin (A) is a cyclic olefin polymer having a protonic polar group, acrylic resin, or polyimide.

Preferably, the resin composition of the present invention further contains a cross-linking agent (E).

Further, according to the present invention, there is provided a semiconductor device board which is provided with a resin film comprised of any of the above resin compositions.

### Effects of the Invention

According to the present invention, it is possible to provide a resin composition which can give a resin film which is high in flatness and which has excellent light resistance and heat resistance and a semiconductor device board which is provided with a resin film which is comprised of such a resin composition. In particular, according to the present invention, it is possible to provide a resin composition which can give a resin film which is high in flatness and which has excellent light resistance and heat resistance even after baking and a semiconductor device board which is provided with a resin film which is comprised of such a resin composition.

### DESCRIPTION OF EMBODIMENTS

The resin composition of the present invention is a resin composition which contains a binder resin (A), radiation-sensitive compound (B), silane-modified resin (C), and antioxidant (D), wherein a content of the silane-modified resin (C) is 0.1 to 150 parts by weight with respect to 100 parts by weight of the binder resin (A), a content of the antioxidant (D) is 0.1 to 10 parts by weight with respect to 100 parts by weight of the binder resin (A), and an amount of warping is 14 μm or less when using the resin composition to form a thickness 2 to 3 μm resin film and baking the formed resin film at 230° C.

(Binder Resin (A))

The binder resin (A) used in the present invention is not particularly limited, but is preferably a cyclic olefin polymer having a protonic polar group (A1), acrylic resin (A2), polyimide (A3), cardo resin (A4), or polysiloxane (A5). Among these, a cyclic olefin polymer having a protonic polar group (A1) is particularly preferable.

These binder resins (A) may be used alone or may be used jointly as two or more types.

As the cyclic olefin polymer having a protonic polar group (A1) (below, simply referred to as the “cyclic olefin polymer (A1)”), a polymer of one or more cyclic olefin monomers or a copolymer of one or more cyclic olefin monomers and a monomer which can be copolymerized with the same may be mentioned, but in the present invention, as the monomer for forming the cyclic olefin polymer (A1), it is preferable to use at least a cyclic olefin monomer which has a protonic polar group (a).

Here, the “protonic polar group” means a group which contains an atom which belongs to Group XV or Group XVI of the Periodic Table to which a hydrogen atom is directly bonded. Among the atoms which belong to Group XV or Group XVI of the Periodic Table, an atom which belongs to Period 1 or Period 2 of Group XV or Group XVI of the Periodic Table is preferable, an oxygen atom, nitrogen atom, or sulfur atom is more preferable, and an oxygen atom is particularly preferable.

As specific examples of such a protonic polar group, a hydroxyl group, carboxyl group (hydroxycarbonyl group), sulfonic acid group, phosphoric acid group, or other polar group which has an oxygen atom; a primary amino group, secondary amino group, primary amide group, secondary amide group (imide group), or other polar group which has a nitrogen atom; thiol group or other polar group which has a sulfur atom; etc. may be mentioned. Among these as well, a group which has an oxygen atom is preferable, while a carboxyl group is more preferable.

In the present invention, the number of protonic polar groups which are bonded to the cyclic olefin resin having a protonic polar group is not particularly limited. Further, different types of protonic polar groups may also be included.

As specific examples of the cyclic olefin monomer which has a protonic polar group (a) (below, suitably referred to as the “monomer (a)”), 2-hydroxycarbonylbicyclo[2.2.1]hept-5-ene, 2-methyl-2-hydroxycarbonylbicyclo[2.2.1]hept-5-ene, 2-carboxymethyl-2-hydroxycarbonylbicyclo[2.2.1]hept-5-ene, 2-hydroxycarbonyl-2-methoxycarbonylmethylbicyclo[2.2.1]hept-5-ene, 2-hydroxycarbonyl-2-ethoxycarbonylmethylbicyclo[2.2.1]hept-5-ene, 2-hydroxycarbonyl-2-propoxycarbonylmethylbicyclo[2.2.1]hept-5-ene, 2-hydroxycarbonyl-2-butoxycarbonylmethylbicyclo[2.2.1]hept-5-ene, 2-hydroxycarbonyl-2-pentyloxycarbonylmethylbicyclo[2.2.1]hept-5-ene, 2-hydroxycarbonyl-2-hexyloxycarbonylmethylbicyclo[2.2.1]hept-5-ene, 2-hydroxycarbonyl-2-cyclohexyloxycarbonylmethylbicyclo[2.2.1]hept-5-ene, 2-hydroxycarbonyl-2-phenoxycarbonylmethylbicyclo[2.2.1]hept-5-ene, 2-hydroxycarbonyl-2-naphthyloxycarbonylmethylbicyclo[2.2.1]hept-5-ene, 2-hydroxycarbonyl-2-biphenyloxycarbonylmethylbicyclo[2.2.1]hept-5-ene, 2-hydroxycarbonyl-2-benzyloxycarbonylmethylbicyclo[2.2.1]hept-5-ene, 2-hydroxycarbonyl-2-hydroxyethoxycarbonylmethylbicyclo[2.2.1]hept-5-ene, 2,3-dihydroxycarbonylbicyclo[2.2.1]hept-5-ene, 2-hydroxycarbonyl-3-methoxycarbonylbicyclo[2.2.1]hept-5-ene, 2-hydroxycarbonyl-3-ethoxycarbonylbicyclo[2.2.1]hept-5-ene, 2-hydroxycarbonyl-3-propoxycarbonylbicyclo[2.2.1]hept-5-ene, 2-hydroxycarbonyl-3-butoxycarbonylbicyclo[2.2.1]hept-5-ene, 2-hydroxycarbonyl-3-pentyloxycarbonylbicyclo[2.2.1]hept-5-ene, 2-hydroxycarbonyl-3-hexyloxycarbonylbicyclo[2.2.1]hept-5-ene, 2-hydroxycarbonyl-3-cyclohexyloxycarbonylbicyclo[2.2.1]hept-5-ene, 2-hydroxycarbonyl-3-phenoxycarbonylbicyclo[2.2.1]hept-5-ene, 2-hydroxycarbonyl-3-naphthyloxycarbonylbicyclo[2.2.1]hept-5-ene, 2-hydroxycarbonyl-3-biphenyloxycarbonylbicyclo[2.2.1]hept-5-ene, 2-hydroxycarbonyl-3-benzyloxycarbonylbicyclo[2.2.1]hept-5-ene, 2-hydroxycarbonyl-3-hydroxyethoxycarbonylbicyclo[2.2.1]hept-5-ene, 2-hydroxycarbonyl-3-hydroxycarbonylmethylbicyclo[2.2.1]hept-5-ene, 3-methyl-2-hydroxycarbonylbicyclo[2.2.1]hept-5-ene, 3-hydroxymethyl-2-hydroxycarbonylbicyclo[2.2.1]hept-5-ene, 2-hydroxycarbonyltricyclo[5.2.1.0^{2,6}]deca-3,8-diene, 4-hydroxycarbonyltetracyclo[6.2.1.1^{3,6}.0^{2,7}]dodec-9-ene, 4-methyl-4-hydroxycarbonyltetracyclo[6.2.1.1^{3,6}.0^{2,7}]dodec-9-ene, 4,5-dihydroxycarbonyltetracyclo[6.2.1.1^{3,6}.0^{2,7}]dodec-9-ene, 4-carboxymethyl-4-hydroxycarbonyltetracyclo[6.2.1.1^{3,6}.0^{2,7}]dodec-9-ene, N-(hydroxycarbonylmethyl)bicyclo[2.2.1]hept-5-ene-2,3-dicarboxylmide, N-(hydroxycarbonylethyl)bicyclo[2.2.1]hept-5-ene-2,3-dicarboxylmide, N-(hydroxycarbonylpentyl)bicyclo[2.2.1]hept-5-ene-2,3-dicarboxylmide, N-(dihydroxycarbonylethyl)bicycle[2.2.1]hept-5-ene-2,3-dicarboxylmide, N-(dihydroxycarbonylpropyl)bicycle[2.2.1]hept-5-ene-2,3-dicarboxylmide, N-(hydroxycarbonylphenetyl)bicyclo[2.2.1]hept-5-ene-2,3-dicarboxylmide, N-(2-(4-hydroxyphenyl)-1-(hydroxycarbonyl)ethyl)bicyclo[2.2.1]hept-5-ene-2,3-dicarboxylmide, N-(hydroxycarbonylphenyl)bicyclo[2.2.1]hept-5-ene-2,3-dicarboxylmide, or other carboxy-group containing cyclic olefin; 2-(4-hydroxyphenyl)bicyclo[2.2.1]hept-5-ene, 2-methyl-2-(4-hydroxyphenyl)bicyclo[2.2.1]hept-5-ene, 4-(4-hydroxyphenyl)tetracyclo[6.2.1.1^{3,6}.0^{2,7}]dodec-9-ene, 4-methyl-4-(4-hydroxyphenyl)tetracyclo[6.2.1.1^{3,6}.0^{2,7}]dodec-9-ene, 2-hydroxybicyclo[2.2.1]hept-5-ene, 2-hydroxymethylbicyclo[2.2.1]hept-5-ene, 2-hydroxyethylbicyclo[2.2.1]hept-5-ene, 2-methyl-2-hydroxymethylbicyclo[2.2.1]hept-5-ene, 2,3-dihydroxymethylbicyclo[2.2.1]hept-5-ene, 2-(hydroxyethoxycarbonyl)bicyclo[2.2.1]hept-5-ene, 2-methyl-2-(hydroxyethoxycarbonyl)bicyclo[2.2.1]hept-5-ene, 2-(1-hydroxy-1-trifluoromethyl-2,2,2-trifluoroethyl)bicyclo[2.2.1]hept-5-ene, 2-(2-hydroxy-2-trifluoromethyl-3,3,3-trifluoropropyl)bicyclo[2.2.1]hept-5-ene, 3-hydroxytricyclo[5.2.1.0^{2,6}]deca-4,8-diene, 3-hydroxymethyltricyclo[5.2.1.0^{2,6}]deca-4,8-diene, 4-hydroxytetracyclo[6.2.1.1^{3,6}.0^{2,7}]dodec-9-ene, 4-hydroxymethyltetracyclo[6.2.1.1^{3,6}.0^{2,7}]dodec-9-ene, 4,5-dihydroxymethyltetracyclo[6.2.1.1^{3,6}.0^{2,7}]dodec-9-ene, 4-(hydroxyethoxycarbonyl)tetracyclo[6.2.1.1^{3,6}.0^{2,7}]dodec-9-ene, 4-methyl-4-(hydroxyethoxycarbonyl)tetracyclo[6.2.1.1^{3,6}.0^{2,7}]dodec-9-ene, N-(hydroxyethyl)bicyclo[2.2.1]hept-5-ene-2,3-dicarboxylmide, N-(hydroxyphenyl)bicyclo[2.2.1]hept-5-ene-2,3-dicarboxylmide, or other hydroxyl-group containing cyclic olefin, etc. may be mentioned. Among these, from the viewpoint of the higher adhesion of the obtained resin film, a carboxy-group containing cyclic olefin is preferably contained, while 4-hydroxycarbonyltetracyclo[6.2.1.1^{3,6}.0^{2,7}]dodec-9-ene is particularly preferably contained. These monomers (a) may be used alone or may be used in combination in two or more types.

The ratio of content of the units of the monomer (a) in the cyclic olefin polymer (A1) is preferably 10 to 90 mol % with respect to the total monomer units. If the ratio of content of the units of the monomer (a) is too small, when adding a radiation-sensitive compound to the resin composition of the present invention, the radiation sensitivity is liable to become insufficient or undissolved residue is liable to be formed at the time of development. If too great, the solubility of the cyclic olefin polymer (A1) in the polar solvent is liable to become insufficient.

Note that, the more preferable range of the ratio of content of the units of the monomer (a) differs depending on the type of the resin film which is formed by the resin composition of the present invention. Specifically, when the resin film is a protective film of an active matrix board or sealing film of an organic EL device board or other resin film in which patterning is performed by photolithography, the ratio of content of the units of the monomer (a) is more preferably 40 to 70 mol %, particularly preferably 50 to 60 mol %. On the other hand, when the resin film is a gate insulating film of an active matrix board or picture element separating film of an organic EL device board or other resin film in which patterning is not performed by photolithography, the ratio of content of the units of the monomer (a) is more preferably 20 to 80 mol %, particularly preferably 30 to 70 mol %.

Further, the cyclic olefin polymer (A1) used in the present invention may be a copolymer which is obtained by copolymerization of a cyclic olefin monomer which has a protonic polar group (a) and a copolymerizable monomer (b) with the same. As the copolymerizable monomer, a cyclic olefin monomer which has a polar group other than a protonic polar group (b1), a cyclic olefin monomer which does not have a polar group (b2), and a monomer other than a cyclic olefin (b3) (below, suitably referred to as the “monomer (b1)”, “monomer (b2)”, “monomer (b3)) may be mentioned.

As the cyclic olefin monomer which has a polar group other than a protonic polar group (b1), for example, a cyclic olefin which has an N-substituted imide group, ester group, cyano group, acid anhydride group, or halogen atom, may be mentioned.

As a cyclic olefin which has an N-substituted imide group, for example, a monomer which is expressed by the following formula (1) or a monomer which is expressed by the following formula (2) may be mentioned.

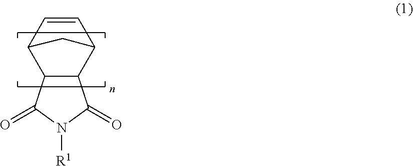

(in formula (1), R¹ indicates a hydrogen atom or a C₁ to C₁₆ alkyl group or aryl group while n is an integer of 1 or 2).

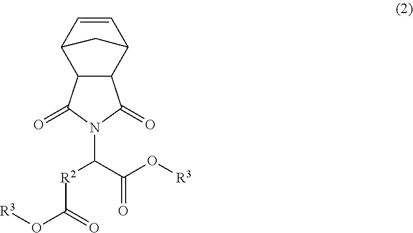

(in formula (2), R² indicates a C₁ to C₃ alkylene group, while R³ is a C₁ to C₁₀ alkyl group or C₁ to C₁₀ halogenated alkyl group).

In the above formula (1), R¹ is a C₁ to C₁₆ alkyl group or aryl group. As specific examples of the alkyl group, a methyl group, ethyl group, n-propyl group, n-butyl group, n-pentyl group, n-hexyl group, n-heptyl group, n-octyl group, n-nonyl group, n-decyl group, n-undecyl group, n-dodecyl group, n-tridecyl group, n-tetradecyl group, n-pentadecyl group, n-hexadecyl group, or other linear alkyl group; cyclopropyl group, cyclobutyl group, cyclopentyl group, cyclohexyl group, cycloheptyl group, cyclooctyl group, cyclononyl group, cyclodecyl group, cycloundecyl group, cyclododecyl group, norbornyl group, bornyl group, isobornyl group, decahydronaphthyl group, tricyclodecanyl group, adamantyl group, or other cyclic alkyl group; 2-propyl group, 2-butyl group, 2-methyl-1-propyl group, 2-methyl-2-propyl group, 1-methylbutyl group, 2-methylbutyl group, 1-methylpentyl group, 1-ethylbutyl group, 2-methylhexyl group, 2-ethylhexyl group, 4-methylheptyl group, 1-methylnonyl group, 1-methyltridecyl group, 1-methyltetradecyl group, or other branched alkyl group; etc. may be mentioned. Further, as specific examples of the aryl group, a benzyl group etc. may be mentioned. Among these as well, due to the excellent heat resistance and solubility in a polar solvent, a C₆ to C₁₄ alkyl group and aryl group are preferable, while a C₆ to C₁₀ alkyl group and aryl group are more preferable. If the number of carbon atoms of the group is too small, the solubility in a polar solvent is liable to become inferior, while if it is too great, the heat resistance is liable to become inferior, and when patterning a resin film, the patterns are liable to melt and to end up being lost by the heat.

As specific examples of the monomer which is expressed by the above formula (1), bicyclo[2.2.1]hept-5-ene-2,3-dicarboxylmide, N-phenyl-bicyclo[2.2.1]hept-5-ene-2,3-dicarboxylmide, N-methylbicyclo [2.2.1]hept-5-ene-2,3-dicarboxylmide, N-ethylbicyclo[2.2.1]hept-5-ene-2,3-dicarboxylmide, N-propylbicyclo[2.2.1]hept-5-ene-2,3-dicarboxylmide, N-butylbicyclo[2.2.1]hept-5-ene-2,3-dicarboxylmide, N-cyclohexylbicyclo[2.2.1]hept-5-ene-2,3-dicarboxylmide, N-adamantylbicyclo[2.2.1]hept-5-ene-2,3-dicarboxylmide, N-(1-methylbutyl)-bicyclo[2.2.1]hept-5-ene-2,3-dicarboxylmide, N-(2-methylbutyl)-bicyclo[2.2.1]hept-5-ene-2,3-dicarboxylmide, N-(1-methylpentyl)-bicyclo[2.2.1]hept-5-ene-2,3-dicarboxylmide, N-(2-methylpentyl)-bicyclo[2.2.1]hept-5-ene-2,3-dicarboxylmide, N-(1-ethylbutyl)-bicyclo[2.2.1]hept-5-ene-2,3-dicarboxylmide, N-(2-ethylbutyl)-bicyclo[2.2.1]hept-5-ene-2,3-dicarboxylmide, N-(1-methylhexyl)-bicyclo[2.2.1]hept-5-ene-2,3-dicarboxylmide, N-(2-methylhexyl)-bicyclo[2.2.1]hept-5-ene-2,3-dicarboxylmide, N-(3-methylhexyl)-bicyclo[2.2.1]hept-5-ene-2,3-dicarboxylmide, N-(1-butylpentyl)-bicyclo[2.2.1]hept-5-ene-2,3-dicarboxylmide, N-(2-butylpentyl)-bicyclo[2.2.1]hept-5-ene-2,3-dicarboxylmide, N-(1-methylheptyl)-bicyclo[2.2.1]hept-5-ene-2,3-dicarboxylmide, N-(2-methylheptyl)-bicyclo[2.2.1]hept-5-ene-2,3-dicarboxylmide, N-(3-methylheptyl)-bicyclo[2.2.1]hept-5-ene-2,3-dicarboxylmide, N-(4-methylheptyl)-bicyclo[2.2.1]hept-5-ene-2,3-dicarboxylmide, N-(1-ethylhexyl)-bicyclo[2.2.1]hept-5-ene-2,3-dicarboxylmide, N-(2-ethylhexyl)-bicyclo[2.2.1]hept-5-ene-2,3-dicarboxylmide, N-(3-ethylhexyl)-bicyclo[2.2.1]hept-5-ene-2,3-dicarboxylmide, N-(1-propylpentyl)-bicyclo[2.2.1]hept-5-ene-2,3-dicarboxylmide, N-(2-propylpentyl)-bicyclo[2.2.1]hept-5-ene-2,3-dicarboxylmide, N-(1-methyloctyl)-bicyclo[2.2.1]hept-5-ene-2,3-dicarboxylmide, N-(2-methyloctyl)-bicyclo[2.2.1]hept-5-ene-2,3-dicarboxylmide, N-(3-methyloctyl)-bicyclo[2.2.1]hept-5-ene-2,3-dicarboxylmide, N-(4-methyloctyl)-bicyclo[2.2.1]hept-5-ene-2,3-dicarboxylmide, N-(1-ethylheptyl)-bicyclo[2.2.1]hept-5-ene-2,3-dicarboxylmide, N-(2-ethylheptyl)-bicyclo[2.2.1]hept-5-ene-2,3-dicarboxylmide, N-(3-ethylheptyl)-bicyclo[2.2.1]hept-5-ene-2,3-dicarboxylmide, N-(4-ethylheptyl)-bicyclo[2.2.1]hept-5-ene-2,3-dicarboxylmide, N-(1-propylhexyl)-bicyclo[2.2.1]hept-5-ene-2,3-dicarboxylmide, N-(2-propylhexyl)-bicyclo[2.2.1]hept-5-ene-2,3-dicarboxylmide, N-(3-propylhexyl)-bicyclo[2.2.1]hept-5-ene-2,3-dicarboxylmide, N-(1-methylnonyl)-bicyclo[2.2.1]hept-5-ene-2,3-dicarboxylmide, N-(2-methylnonyl)-bicyclo[2.2.1]hept-5-ene-2,3-dicarboxylmide, N-(3-methylnonyl)-bicyclo[2.2.1]hept-5-ene-2,3-dicarboxylmide, N-(4-methylnonyl)-bicyclo[2.2.1]hept-5-ene-2,3-dicarboxylmide, N-(5-methylnonyl)-bicyclo[2.2.1]hept-5-ene-2,3-dicarboxylmide, N-(1-ethyloctyl)-bicyclo[2.2.1]hept-5-ene-2,3-dicarboxylmide, N-(2-ethyloctyl)-bicyclo[2.2.1]hept-5-ene-2,3-dicarboxylmide, N-(3-ethyloctyl)-bicyclo[2.2.1]hept-5-ene-2,3-dicarboxylmide, N-(4-ethyloctyl)-bicyclo[2.2.1]hept-5-ene-2,3-dicarboxylmide, N-(1-methyldecyl)-bicyclo[2.2.1]hept-5-ene-2,3-dicarboxylmide, N-(1-methyldodecyl)-bicyclo[2.2.1]hept-5-ene-2,3-dicarboxylmide, N-(1-methylundecyl)-bicyclo[2.2.1]hept-5-ene-2,3-dicarboxylmide, N-(1-methyldodecyl)-bicyclo[2.2.1]hept-5-ene-2,3-dicarboxylmide, N-(1-methyltridecyl)-bicyclo[2.2.1]hept-5-ene-2,3-dicarboxylmide, N-(1-methyltetradecyl)-bicyclo[2.2.1]hept-5-ene-2,3-dicarboxylmide, N-(1-methylpentadecyl)-bicyclo[2.2.1]hept-5-ene-2,3-dicarboxylmide, N-phenyl-tetracyclo[6.2.1.1^{3,6}.0^{2,7}]dodec-9-ene-4,5-dicarboxylmide, N-(2,4-dimethoxyphenyl)-tetracyclo[6.2.1.1^{3,6}.0^{2,7}]dodec-9-ene-4,5-dicarboxylmide etc. may be mentioned. Note that, these may be used alone or may be used in combinations of two or more types.

On the other hand, in the above formula (2), R² is a C₁ to C₃ alkylene group. As the C₁ to C₃ alkylene group, a methylene group, ethylene group, propylene group, and isopropylene group may be mentioned. Among these as well, since the polymerization activity is good, a methylene group and ethylene group are preferable.

Further, in the above formula (2), R³ is a C₁ to C₁₀ alkyl group or C₁ to C₁₀ halogenated alkyl group. As the C₁ to C₁₀ alkyl group, for example, a methyl group, ethyl group, propyl group, isopropyl group, butyl group, sec-butyl group, tert-butyl group, hexyl group, cyclohexyl group, etc. may be mentioned. As the C₁ to C₁₀ halogenated alkyl group, for example, a fluoromethyl group, chloromethyl group, bromomethyl group, difluoromethyl group, dichloromethyl group, difluoromethyl group, trifluoromethyl group, trichloromethyl group, 2,2,2-trifluoroethyl group, pentafluoroethyl group, heptafluoropropyl group, perfluorobutyl group, perfluoropentyl group, etc. may be mentioned. Among these, due to the excellent solubility in a polar solvent, as R³, a methyl group and ethyl group are preferable.

Note that, the monomer which is expressed by the above formulas (1) and (2) may, for example, be obtained by an amidation reaction of the corresponding amine and 5-norbornene-2,3-dicarboxylic acid anhydride. Further, the obtained monomer may be efficiently isolated by separating and refining the reaction solution of an amidation reaction by a known method.

As the cyclic olefin which has an ester group, for example, 2-acetoxybicyclo[2.2.1]hept-5-ene, 2-acetoxymethylbicyclo[2.2.1]hept-5-ene, 2-methoxycarbonylbicyclo[2.2.1]hept-5-ene, 2-ethoxycarbonylbicyclo[2.2.1]hept-5-ene, 2-propoxycarbonylbicyclo[2.2.1]hept-5-ene, 2-butoxycarbonylbicyclo[2.2.1]hept-5-ene, 2-cyclohexyloxycarbonylbicyclo[2.2.1]hept-5-ene, 2-methyl-2-methoxycarbonylbicyclo[2.2.1]hept-5-ene, 2-methyl-2-ethoxycarbonylbicyclo[2.2.1]hept-5-ene, 2-methyl-2-propoxycarbonylbicyclo[2.2.1]hept-5-ene, 2-methyl-2-butoxycarbonylbicyclo[2.2.1]hept-5-ene, 2-methyl-2-cyclohexyloxycarbonylbicyclo[2.2.1]hept-5-ene, 2-(2,2,2-trifluoroethoxycarbonyl)bicyclo[2.2.1]hept-5-ene, 2-methyl-2-(2,2,2-trifluoroethoxycarbonyl)bicyclo[2.2.1]hept-5-ene, 2-methoxycarbonyltricyclo[5.2.1.0^{2,6}]dec-8-ene, 2-ethoxycarbonyltricyclo[5.2.1.0^{2,6}]dec-8-ene, 2-propoxycarbonyltricyclo [5.2.1.0^{2,6}]dec-8-ene, 4-acetoxytetracyclo[6.2.1.1^{3,6}.0^{2,7}]dodec-9-ene, 4-methoxycarbonyltetracyclo[6.2.1.1^{3,6}.0^{2,7}]dodec-9-ene, 4-ethoxycarbonyltetracyclo[6.2.1.1^{3,6}.0^{2,7}]dodec-9-ene, 4-propoxycarbonyltetracyclo[6.2.1.1^{3,6}.0^{2,7}]dodec-9-ene, 4-butoxycarbonyltetracyclo[6.2.1.1^{3,6}.0^{2,7}]dodec-9-ene, 4-methyl-4-methoxycarbonyltetracyclo[6.2.1.1^{3,6}.0^{2,7}]dodec-9-ene, 4-methyl-4-ethoxycarbonyltetracyclo[6.2.1.1^{3,6}.0^{2,7}]dodec-9-ene, 4-methyl-4-propoxycarbonyltetracyclo[6.2.1.1^{3,6}.0^{2,7}]dodec-9-ene, 4-methyl-4-butoxycarbonyltetracyclo[6.2.1.1^{3,6}.0^{2,7}]dodec-9-ene, 4-(2,2,2-trifluoroethoxycarbonyl)tetracyclo[6.2.1.1^{3,6}.0^{2,7}]dodec-9-ene, 4-methyl-4-(2,2,2-trifluoroethoxycarbonyl)tetracyclo[6.2.1.1^{3,6}.0^{2,7}]dodec-9-ene, etc. may be mentioned.

As the cyclic olefin which has a cyano group, for example, 4-cyanotetracyclo[6.2.1.1^{3,6}.0^{2,7}]dodec-9-ene, 4-methyl-4-cyanotetracyclo[6.2.1.1^{3,6}.0^{2,7}]dodec-9-ene, 4,5-dicyanotetracyclo[6.2.1.1^{3,6}.0^{2,7}]dodec-9-ene, 2-cyanobicyclo[2.2.1]hept-5-ene, 2-methyl-2-cyanobicyclo[2.2.1]hept-5-ene, 2,3-dicyanobicyclo[2.2.1]hept-5-ene, etc. may be mentioned.

As the cyclic olefin which has an acid anhydride group, for example, tetracyclo[6.2.1.1^{3,6}.0^{2,7}]dodec-9-ene-4,5-dicarboxylic acid anhydride, bicyclo[2.2.1]hept-5-ene-2,3-dicarboxylic acid anhydride, 2-carboxymethyl-2-hydroxycarbonylbicyclo[2.2.1]hept-5-ene anhydride, etc. may be mentioned.

As the cyclic olefin which has a halogen atom, for example, 2-chlorobicyclo[2.2.1]hept-5-ene, 2-chloromethylbicyclo[2.2.1]hept-5-ene, 2-(chlorophenyl)bicyclo[2.2.1]hept-5-ene, 4-chlorotetracyclo[6.2.1.1^{3,6}.0^{2,7}]dodec-9-ene, 4-methyl-4-chlorotetracyclo[6.2.1.1^{3,6}.0^{2,7}]dodec-9-ene, etc. may be mentioned.

These monomers (b1) may be used alone or may be used in combinations of two or more types.

As the cyclic olefin monomer which does not have a polar group (b2), bicyclo[2.2.1]hept-2-ene (also referred to as “norbornene”), 5-ethyl-bicyclo[2.2.1]hept-2-ene, 5-butyl-bicyclo[2.2.1]hept-2-ene, 5-ethylidene-bicyclo[2.2.1]hept-2-ene, 5-methylidene-bicyclo[2.2.1]hept-2-ene, 5-vinyl-bicyclo[2.2.1]hept-2-ene, tricyclo[5.2.1.0^{2,6}]deca-3,8-diene (common name: dicyclopentadiene), tetracyclo[10.2.1.0^{2,11}.0^{4,9}]pentadeca-4,6,8,13-tetraene, tetracyclo[6.2.1.1^{3,6}.0^{2,7}]dodec-4-ene (also referred to as “tetracyclododecene”), 9-methyl-tetracyclo[6.2.1.1^{3,6}.0^{2,7}]dodec-4-ene, 9-ethyl-tetracyclo[6.2.1.1^{3,6}.0^{2,7}]dodec-4-ene, 9-methylidene-tetracyclo[6.2.1.1^{3,6}.0^{2,7}]dodec-4-ene, 9-ethylidene-tetracyclo[6.2.1.1^{3,6}.0^{2,7}]dodec-4-ene, 9-vinyl-tetracyclo[6.2.1.1^{3,6}.0^{2,7}]dodec-4-ene, 9-propenyl-tetracyclo[6.2.1.1^{3,6}.0^{2,7}]dodec-4-ene, pentacyclo[9.2.1.1^{3,9}.0^{2,10}.0^{4,8}]pentadeca-5,12-diene, cyclobutene, cyclopentene, cyclopentadiene, cyclohexene, cycloheptene, cyclooctene, cyclooctadiene, indene, 3a,5,6,7a-tetrahydro-4,7-methano-1H-indene, 9-phenyl-tetracyclo[6.2.1.1^{3,6}.0^{2,7}]dodec-4-ene, tetracyclo[9.2.1.0^{2,10}.0^{3,8}]tetradeca-3,5,7,12-tetraene, pentacyclo[9.2.1.1^{3,9}.0^{2,10}.0^{4,8}]pentadec-12-ene, etc. may be mentioned.

These monomers (b2) may be used alone or may be used in combinations of two or more types.

As specific examples of monomers (b3) other than cyclic olefins, ethylene; propylene, 1-butene, 1-pentene, 1-hexene, 3-methyl-1-butene, 3-methyl-1-pentene, 3-ethyl-1-pentene, 4-methyl-1-pentene, 4-methyl-1-hexene, 4,4-dimethyl-1-hexene, 4,4-dimethyl-1-pentene, 4-ethyl-1-hexene, 3-ethyl-1-hexene, 1-octene, 1-decene, 1-dodecene, 1-tetradecene, 1-hexadecene, 1-octadecene, 1-eicosene, or other C₂ to C₂₀ α-olefin; 1,4-hexadiene, 4-methyl-1,4-hexadiene, 5-methyl-1,4-hexadiene, 1,7-octadiene, or other non-conjugated dienes and their derivatives; etc. may be mentioned. Among these as well, α-olefins, in particular ethylene, are preferable.

These monomers (b3) may be used alone or may be used in combinations of two or more types.

Among these monomers (b1) to (b3) as well, from the viewpoint of the effect of the present invention becoming even more remarkable, a cyclic olefin monomer which has a polar group other than a protonic polar group (b1) is preferable, while a cyclic olefin which has an N-substituted imide group is particularly preferable.

In the cyclic olefin polymer (A1), the ratio of content of the units of the copolymerizable monomer (b) is preferably 10 to 90 mol % with respect to the total monomer units. If the ratio of content of the units of the copolymerizable monomer (b) is too small, the solubility of the cyclic olefin polymer (A1) in a polar solvent is liable to become insufficient. If too great, when adding a radiation-sensitive compound to the resin composition of the present invention, the radiation sensitivity is liable to become insufficient and undissolved residue is liable to occur at the time of development.

Note that, the more preferable range of the ratio of content of the units of the copolymerizable monomer (b) differs depending on the type of the resin film which is formed by the resin composition of the present invention. Specifically, when the resin film is a protective film of an active matrix board or a sealing film of an organic EL device board or other resin film in which patterning is performed by photolithography, the ratio of content of units of the copolymerizable monomer (b) is more preferably 30 to 60 mol %, particularly preferably 40 to 50 mol %. On the other hand, when the resin film is a gate insulating film of an active matrix board or a picture element separating film of an organic EL device board or other resin film in which patterning is not performed by photolithography, the ratio of content of units of the copolymerizable monomer (b) is more preferably 20 to 80 mol %, particularly preferably 30 to 70 mol %.

Note that, in the present invention, by introducing a protonic polar group into a cyclic olefin polymer which does not have a protonic polar group by utilizing a known modifying agent, the polymer may be made the cyclic olefin polymer (A1).

A polymer which does not have a protonic polar group can be obtained by freely combining and polymerizing at least one type of the above-mentioned monomers (b1) and (b2) and a monomer (b3) in accordance with need.

As a modifying agent for introduction of a protonic polar group, usually a compound which has a protonic polar group and a reactive carbon-carbon unsaturated bond in a single molecule is used.

As specific examples of this compound, acrylic acid, methacrylic acid, angelic acid, tiglic acid, oleic acid, elaidic acid, erucic acid, brassidic acid, maleic acid, fumaric acid, citraconic acid, mesaconic acid, itaconic acid, atropic acid, cinnamic acid, or other unsaturated carboxylic acid; allyl alcohol, methylvinyl methanol, crotyl alcohol, methacryl alcohol, 1-phenylethen-1-ol, 2-propen-1-ol, 3-buten-1-ol, 3-buten-2-ol, 3-methyl-3-buten-1-ol, 3-methyl-2-buten-1-ol, 2-methyl-3-buten-2-ol, 2-methyl-3-buten-1-ol, 4-penten-1-ol, 4-methyl-4-penten-1-ol, 2-hexen-1-ol, or other unsaturated alcohol; etc. may be mentioned.

The modification reaction of a polymer which uses these modifying agents may be performed in accordance with an ordinary method and is usually performed in the presence of a radical generator.

Note that, the cyclic olefin polymer (A1) used in the present invention may be a ring-opening polymer which is obtained by ring opening polymerization of the above-mentioned monomers. Alternatively, it may be an addition polymer which is obtained by addition polymerization of the above-mentioned monomers, but from the viewpoint of the effect of the present invention becoming much more remarkable, a ring-opening polymer is preferable.

A ring-opening polymer may be produced by ring-opening metathesis polymerization of a cyclic olefin monomer which has a protonic polar group (a) and a copolymerizable monomer (b) which is used in accordance with need, in the presence of a metathesis reaction catalyst.

The metathesis reaction catalyst may be any catalyst of a transition metal compound of Group III to XI of the Periodic Table which promotes ring-opening metathesis polymerization of a cyclic olefin monomer which has a protonic polar group (a). For example, as the metathesis reaction catalyst, one which is described in Olefin Metathesis and Metathesis Polymerization (K. J. Ivin and J. C. Mol, Academic Press, San Diego 1997) may be used.

As the metathesis reaction catalyst, for example, a complex catalyst of a transition metal of Group III to XI of the Periodic Table and carbene may be mentioned. Among these as well, use of a ruthenium-carbene carbene complex catalyst is preferable.

As the complex catalyst of a transition metal of Group III to XI of the Periodic Table and carbene, for example, a tungsten-alkylidene complex catalyst, molybdenum-alkylidene complex catalyst, rhenium-alkylidene alkylidene complex catalyst, ruthenium-carbene complex catalyst, etc. may be mentioned.

As specific examples of a tungsten-alkylidene complex catalyst, W(N-2,6-Prⁱ₂C₆H₃)(CHBu^{t})(OBu^{t})₂, W(N-2,6-Prⁱ₂C₆H₃)(CHBu^{t})(OCMeCF₃)₂, W(N-2,6-Prⁱ₂C₆H₃)(CHBu^{t})(OCMe(CF₃)₂)₂, W(N-2,6-Prⁱ₂C₆H₃)(CHCMe₂Ph)(OBu^{t})₂, W(N-2,6-Prⁱ₂C₆H₃)(CHCMe₂Ph)(OCMe₂CF₃)₂, W(N-2,6-Prⁱ₂C₆H₃)(CHCMe₂Ph)(OCMe (CF₃)₂)₂, etc. may be mentioned.

As specific examples of a molybdenum-alkylidene complex catalyst, Mo(N-2,6-Prⁱ₂C₆H₃)(CHBu^{t})(OBu^{t})₂, Mo(N-2,6-Prⁱ₂C₆H₃)(CHBu^{t}) (OCMe₂CF₃)₂, Mo(N-2,6-Prⁱ₂C₆H₃)(CHBu^{t})(OCMe (CF₃)₂)₂, Mo(N-2,6-Prⁱ₂C₆H₃) (CHCMe₂Ph)(OBu^{t})₂, Mo(N-2,6-Prⁱ₂C₆H₃)(CHCMe₂Ph)(OCMe₂CF₃)₂, Mo(N-2,6-Prⁱ₂C₆H₃) (CHCMe₂Ph)(OCMe(CF₃)₂)₂, Mo(N-2,6-Prⁱ₂C₆H₃)(CHCMe₂Ph)(BIPHEN), Mo(N-2,6-Prⁱ₂C₆H₃)(CHCMe₂Ph)(BINO)(THF), etc. may be mentioned.

As specific examples of a rhenium alkylidene complex catalyst, Re(CBu^{t})(CHBu^{t})(O-2,6-Prⁱ₂C₆H₃)₂, Re(CBu^{t})(CHBu^{t})(O-2-Bu^{t}C₆H₄)₂, Re(CBu^{t})(CHBu^{t})(OCMe₂CF₃)₂, Re(CBu^{t})(CHBu^{t})(OCMe(CF₃)₂)₂, Re(CBu^{t})(CHBu^{t})(O-2,6-Me₂C₆H₃)₂, etc. may be mentioned.

In the above formula, Prⁱ indicates an isopropyl group, Bu^{t} indicates a tert-butyl group, Me indicates a methyl group, Ph indicates a phenyl group, BIPHEN indicates a 5,5′,6,6′-tetramethyl-3,3′-di-tert-butyl-1,1′-biphenyl-2,2′-dioxy group, BINO indicates a 1,1′-dinaphthyl-2,2′-dioxy group, and THF indicates tetrahydrofuran.

Further, as specific examples of a ruthenium-carbene complex catalyst, a compound which is expressed by the following formula (3) or (4) may be mentioned.

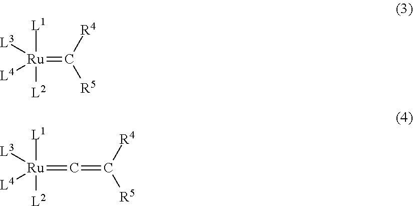

In the above formulas (3) and (4), ═CR⁴R⁵ and ═C═CR⁴R⁵ are carbene compounds which include carbene carbons as the reaction center. R⁴ and R⁵ respectively independently represent a hydrogen atom or a C₁ to C₂₀ hydrocarbon group which may include a halogen atom, oxygen atom, nitrogen atom, sulfur atom, phosphorus atom, or silicon atom, alkoxy group, aryloxy group, acyloxy group, amino group, acylamino group, diacylamino group, alkylthio group, arylthio group, sulfonyl group, sulfinyl group, phosphino group, and silyl group, while these carbene compounds may include a hetero atom or may not include a hetero atom. L¹ indicates a carbene compound which contains a hetero atom, while L² indicates any neutral electron donor compound.

Here, the hetero atom-containing carbene compound means a compound which contains a carbene carbon and hetero atom. Both L¹ and L² or L¹ are hetero atom-containing carbene compounds. To these carbene carbons which are contained in these, ruthenium metal atoms are directly bonded and groups which contain hetero atoms are bonded.

L³ and L⁴ respectively independently indicate any anionic ligands. Further, two, three, four, five, or six of R⁴, R⁵, L¹, L², L³, and L⁴ may be bonded with each other to form multidentate chelated ligands. Further, as specific examples of hetero atoms, N, O, P, S, As, Se atoms etc. may be mentioned. Among these, from the viewpoint of stable carbene compounds being obtained, N, O, P, and S atoms etc. are preferable, while an N atom is particularly preferable.

In the above formulas (3) and (4), anionic (negative ionic) ligands L³ and L⁴ are ligands which have negative charges when separated from the center metal. For example, a fluorine atom, chlorine atom, bromine atom, iodine atom, or other halogen atoms; diketonate group, alkoxy group, aryloxy group, carboxyl group, or other hydrocarbon group which contains oxygen; chlorinated cyclopentadienyl group or other alicyclic hydrocarbon group which is substituted by a halogen atom, etc. may be mentioned. Among these as well, a halogen atom is preferable, while a chlorine atom is more preferable.

When L² is a neutral electron donor compound other than a hetero atom-containing carbene compound, L² may be any ligand which has a neutral charge when separated from the center metal. As specific examples, carbonyls, amines, pyridines, ethers, nitriles, esters, phosphines, thioethers, aromatic compounds, olefins, isocyanides, thiocyanates, etc. may be mentioned. Among these as well, phosphines and pyridines are preferable, while trialkylphosphines are more preferable. Further, when R⁴ and L² or R⁵ and L² are bonded with each other to form a bidentate chelated ligand, pyridines or ethers are preferable.

As the ruthenium complex catalyst which is expressed by the above formula (3), for example, benzylidene(1,3-dimesitylimidazolydin-2-ylidene)(tricyclohexylphosphine)ruthenium dichloride, (1,3-dimesitylimidazolydin-2-ylidene)(3-methyl-2-buten-1-ylidene) (tricyclopentylphosphine)ruthenium dichloride, ((2-(1-methylethoxy) phenyl)methylene)(1,3-dimesitylimidazolydin-2-ylidene)ruthenium dichloride, benzylidene(1,3-dimesitylimidazolydin-2-ylidene)bis(3-bromopyridine)ruthenium dichloride, (3-(2-pyridinyl)propylidene)(1,3-dimesitylimidazolydin-2-ylidene)ruthenium dichloride, benzylidene(1,3-dimesityl-octahydrobenzimidazol-2-ylidene)(tricyclohexylphosphine) ruthenium dichloride, (3-phenylinden-1-ylidene)(1,3-dimesityl-4-imidazolin-2-ylidene)(tricyclohexylphosphine)ruthenium dichloride, (2-thienylmethylene)(1,3-dimesityl-4-imidazolin-2-ylidene) (tricyclohexylphosphine)ruthenium dichloride, (2-thienylmethylene)(1,3-dimesityl-4,5-dimethyl-4-imidazolin-2-ylidene)(tricyclohexyl phosphine) ruthenium dichloride, (2-thienylmethylene)(1,3,4-triphenyl-4,5-dihydro-1H-1,2,4-triazol-5-ylidene)(tricyclohexylphosphine) ruthenium dichloride, benzylidene(1,3-dimesityl-4-imidazolin-2-ylidene)(tricyclohexylphosphine)ruthenium dichloride, benzylidene(1,3-dimesityl-2,3-dihydrobenzimidazol-2-ylidene)(tricyclohexyl phosphine) ruthenium dichloride, benzylidene(1,3,4-triphenyl-4,5-dihydro-1H-1,2,4-triazol-5-ylidene)(tricyclohexylphosphine)ruthenium dichloride, benzylidene(4,5-dichloro-1,3-dimesityl-4-imidazolin-2-ylidene) (tricyclohexylphosphine)ruthenium dichloride, benzylidene (4,5-dibromo-1,3-dimesityl-4-imidazolin-2-ylidene)(tricyclohexylphosphine)ruthenium dichloride, (3-phenylinden-1-ylidene)(1,3-dimesitylimidazolydin-2-ylidene)(tricyclohexylphosphine)ruthenium dichloride, (3-phenylinden-1-ylidene)(1,3-dimesitylimidazolydin-2-ylidene)bis(pyridine)ruthenium dichloride, ((2-(1-acetylethoxy)phenyl)methylene)(1,3-dimesityl-imidazolydin-2-ylidene)ruthenium dichloride, (phenylthiomethylene)(1,3-dimesitylimidazolydin-2-ylidene)(tricyclohexylphosphine)ruthenium dichloride, (phenylthiomethylene)(1,3-dimesityl-4-imidazolin-2-ylidene)(tricyclohexylphosphine)ruthenium dichloride, (ethylthiomethylene)(1,3-dimesityl-4-imidazolin-2-ylidene) (tricyclohexylphosphine)ruthenium dichloride, ((1-aza-2-oxocyclopentyl) methylene)(1,3-dimesityl-4-imidazolin-2-ylidene)(tricyclohexylphosphine)ruthenium dichloride, ((carbazol-9-yl)methylene)(1,3-dimesityl-4-imidazolin-2-ylidene) (tricyclohexylphosphine)ruthenium dichloride, ((2-(1-methylethoxy)-5-[(N,N-dimethylaminosulfonyl)phenyl)methylene)(1,3-dimesitylimidazolydin-2-ylidene)ruthenium dichloride, ((2-(1-methylethoxy)-5-(trifluoroacetoamino)phenyl)methylene)(1,3-bis(2,6-diisopropylphenyl)imidazolydin-2-ylidene)ruthenium dichloride, benzylidene[1,3-di(1-phenylethyl)-4-imidazolin-2-ylidene](tricyclohexylphosphine)ruthenium dichloride, (1,3-diisopropyl-hexahydropyrimidin-2-ylidene)(ethoxymethylene)(tricyclohexylphosphine) ruthenium dichloride, benzylidene(1,3-dimesitylhexahydropyrimidin-2-ylidene)(tricyclohexylphosphine)ruthenium dichloride, or other ruthenium carbene complex comprised of a hetero atom-containing carbene compound and neutral electron donor compound bonded; benzylidenebis(1,3-dicyclohexyl-4-imidazolin-2-ylidene)ruthenium dichloride, benzylidenebis (1,3-diisopropyl-4-imidazolin-2-ylidene)ruthenium dichloride, or other ruthenium carbene complex comprised of two hetero atom-containing carbene compounds bonded; etc. may be mentioned.

As the ruthenium carbene complex catalyst which is expressed by the above formula (4), for example, (phenylvinylidene)(1,3-dimesitylimidazolydin-2-ylidene)(tricyclohexylphosphine)ruthenium dichloride, (t-butylvinylidene)(1,3-diisopropyl-4-imidazolin-2-ylidene)(tricyclopentylphosphine)ruthenium dichloride, bis(1,3-dicyclohexyl-4-imidazolin-2-ylidene)phenylvinylidene ruthenium dichloride, etc. may be mentioned.

The amount of use of the metathesis reaction catalyst is, by molar ratio of monomer to the catalyst, catalyst:monomer=1:100 to 1:2,000,000, preferably 1:500 to 1:1,000,000, more preferably 1:1,000 to 1:500,000. If the amount of catalyst is too great, removal of the catalyst sometimes becomes difficult, while if too small, sometimes a sufficient polymerization activity cannot be obtained.

The ring-opening polymerization by using a metathesis reaction catalyst can be performed in a solvent or without a solvent. After the polymerization reaction terminates, if performing the hydrogenation reaction as is without separation of the produced polymer, it is preferable that the polymerization is performed in a solvent.

The solvent is not particularly limited so long as a solvent which dissolves the produced polymer and does not inhibit the polymerization reaction. As the solvent which is used, for example, n-pentane, n-hexane, n-heptane, or other aliphatic hydrocarbon; cyclopentane, cyclohexane, methylcyclohexane, dimethylcyclohexane, trimethylcyclohexane, ethylcyclohexane, diethylcyclohexane, decahydronaphthalene, bicycloheptane, tricyclodecane, hexahydroindene, cyclooctane, or other alicyclic hydrocarbon; benzene, toluene, xylene, mesitylene, or other aromatic hydrocarbon; nitromethane, nitrobenzene, acetonitrile, propionitrile, benzonitrile, or other nitrogen-containing hydrocarbon; diethylether, tetrahydrofuran, dioxane, or other ethers; acetone, ethylmethylketone, methylisobutylketone, cyclopentanone, cyclohexanone, or other ketones; methyl acetate, ethyl acetate, ethyl propionate, methyl benzoate, or other esters; chloroform, dichloromethane, 1,2-dichloroethane, chlorobenzene, dichlorobenzene, trichlorobenzene, or other halogenated hydrocarbon; etc. may be mentioned. Among these, aromatic hydrocarbons, alicyclic hydrocarbons, ethers, ketones, or esters are preferably used.

The concentration of the monomer mixture in the solvent is preferably 1 to 50 wt %, more preferably 2 to 45 wt %, furthermore preferably 5 to 40 wt %. If the concentration of the monomer mixture is less than 1 wt %, the productivity of the polymer sometimes becomes poor, while if over 50 wt %, the viscosity after polymerization sometimes becomes too high and subsequent hydrogenation becomes difficult.

The mettahesis reaction catalyst may be dissolved in a solvent to be added to the reaction system or may be added as is without being dissolved. As the solvent used for preparing the catalyst solution, a solvent similar to the solvent which is used for the polymerization reaction may be mentioned.

Further, in the polymerization reaction, it is possible to add a molecular weight adjuster to the reaction system in order to adjust the molecular weight of the polymer. As the molecular weight adjuster, 1-butene, 1-pentene, 1-hexene, 1-octene, or other α-olefin; 1,4-pentadiene, 1,5-hexadiene, 1,6-heptadiene, or other α,ω-diolefin; styrene, vinyltoluene, divinylbenzene, or other styrenes; ethylvinyl ether, isobutylvinyl ether, allylglycidylether, or other ethers; allylchloride or other halogen-containing vinyl compound; allyl acetate, allyl alcohol, glycidyl methacrylate, or other oxygen-containing vinyl compound; acrylonitrile, acrylamide, or other nitrogen-containing vinyl compound etc. may be used. By using a molecular weight adjuster in 0.05 to 50 mol % with respect to the monomer mixture which includes a cyclic olefin monomer which has a protonic polar group (a), it is possible to obtain a polymer which has a desired molecular weight.

The polymerization temperature is not particularly limited, but is usually −100° C. to +200° C., preferably −50° C. to +180° C., more preferably −30° C. to +160° C., furthermore preferably 0° C. to +140° C. The polymerization time is usually 1 minute to 100 hours and can be suitably adjusted in accordance with the progress of the reaction.

On the other hand, the addition polymer can be obtained by polymerization of a cyclic olefin monomer which has a protonic polar group (a) and a copolymerizable monomer (b) which is used in accordance with need by using a known addition polymerization catalyst, for example, a catalyst comprised of a titanium, zirconium, or vanadium compound and organic aluminum compound. These polymerization catalysts may be used alone or in combinations of two or more types. The amount of the polymerization catalyst is, by molar ratio of metal compound in the polymerization catalyst:monomer, usually 1:100 to 1:2,000,000 in range.

Further, when the cyclic olefin polymer (A1) used in the present invention is a ring-opening polymer, furthermore it is preferable to perform a hydrogenation reaction to prepare a hydrogenated product to which a carbon-carbon double bond which is contained in the main chain is hydrogenated. When the cyclic olefin polymer (A1) is a hydrogenated product, the ratio of the carbon-carbon double bond which is hydrogenated (hydrogenation rate) is usually 50% or more. From the viewpoint of the heat resistance, 70% or more is preferable, 90% or more is more preferable, and 95% or more is furthermore preferable.

The hydrogenation rate of the hydrogenated product can be found, for example, by comparing the peak strength which is derived from the carbon-carbon double bonds of the ring-opening polymer in the ¹H-NMR spectrum and the peak strength which is derived from the carbon-carbon double bonds of the hydrogenated product in the ¹H-NMR spectrum.

The hydrogenation reaction can be performed, for example, in the presence of a hydrogenation catalyst by using hydrogen gas to convert the carbon-carbon double bonds in the main chain of the ring-opening polymer to saturated single bonds.

The hydrogenation catalyst which is used may be a homogeneous catalyst or a heterogeneous catalyst etc. and is not particularly limited. One which can be generally used when hydrogenating an olefin compound may be suitably used.

As the homogeneous catalyst, for example, a Ziegler catalyst comprised of a combination of cobalt acetate and triethylaluminum, nickel acetylacetonate and triisobutylaluminum, and titanocene dichloride and n-butyllithium or a combination of zirconocene dichloride and sec-butyllithium, tetrabutoxytitanate and dimethyl magnesium, or other transition metal compound and alkali metal compound; the ruthenium carbene complex catalysts which are described in the above section of ring-opening metathesis reaction catalysts, chlorotris(triphenylphosphine)rhodium, noble metal complex catalysts which are comprised of the ruthenium compounds which are described in Japanese Patent Publication No. 7-2929A, Japanese Patent Publication No. 7-149823A, Japanese Patent Publication No. 11-109460A, Japanese Patent Publication No. 11-158256A, Japanese Patent Publication No. 11-193323A, Japanese Patent Publication No. 11-109460A, etc. may be mentioned.

As the heterogeneous catalyst, for example, a hydrogenation catalyst which is comprised of nickel, palladium, platinum, rhodium, ruthenium, or other metal carried on a carbon, silica, diatomaceous earth, alumina, titanium oxide, or other carrier may be mentioned. More specifically, for example, nickel/silica, nickel/diatomaceous earth, nickel/alumina, palladium/carbon, palladium/silica, palladium/diatomaceous earth, palladium/alumina, etc. may be used. These hydrogenation catalysts may be used alone or in combinations of two or more types.

Among these, from the viewpoint of enabling selective hydrogenation of the carbon-carbon double bonds in a ring-opening polymer without causing modification of the functional groups which are contained in the polymer or other secondary reactions, use of a rhodium, ruthenium, or other nobel metal complex catalyst and palladium/carbon, or other palladium-carrying catalyst is preferable, while use of a ruthenium carbene complex catalyst or palladium-carrying catalyst is more preferable.

The above-mentioned ruthenium carbene complex catalyst may be used as a ring-opening metathesis reaction catalyst and hydrogenation catalyst. In this case, the ring-opening metathesis reaction and hydrogenation reaction may be continuously performed.

Further, when using a ruthenium carbene complex catalyst to continuously perform a ring-opening metathesis reaction and hydrogenation reaction, the method of adding ethylvinyl ether or other vinyl compound or α-olefin or other catalyst modifying agent to activate the catalyst, then start the hydrogenation reaction is also preferably employed. Furthermore, the method of adding triethylamine, N,N-dimethylacetoamide, or other base to improve the activity is preferably employed.

The hydrogenation reaction is usually performed in an organic solvent. The organic solvent may be suitably selected according to the solubility of the hydrogenated product which is produced. An organic solvent which is similar to the above-mentioned polymerization solvent may be used. Therefore, it is also possible to add a hydrogenation catalyst for causing a reaction to the reaction solution or the filtered solution obtained by filtering the methathesis reaction catalyst from the reaction solution after the polymerization reaction without replacing the solvent.

The conditions of the hydrogenation reaction may be suitably selected in accordance with the type of the hydrogenation catalyst which is used. The amount of the hydrogenation catalyst which is used is usually 0.01 to 50 parts by weight with respect to 100 parts by weight of the ring-opening polymer, preferably 0.05 to 20 parts by weight, more preferably 0.1 to 10 parts by weight. The reaction temperature is usually −10° C. to +250° C., preferably 0° C. to +240° C., more preferably 20° C. to +230° C. At a temperature which is lower than this range, the reaction speed becomes slow, while conversely at a higher temperature, secondary reactions are easily caused. The pressure of the hydrogen is usually 0.01 to 10.0 MPa, preferably 0.05 to 8.0 MPa, more preferably 0.1 to 6.0 MPa.

The time of the hydrogenation reaction is suitably selected for controlling the hydrogenation rate. The reaction time is usually 0.1 to 50 hours in range and enables hydrogenation of 50% or more of the carbon-carbon double bonds in the main chain of the polymer, preferably 70% or more, more preferably 90% more, most preferably 95% or more.

Further, the acrylic resin (A2) used in the present invention is not particularly limited, but a homopolymer or copolymer which has at least one of a carboxylic acid which has an acrylic group, a carboxylic acid anhydride which has an acrylic group, or an acrylate compound which contains an epoxy group and acrylate compound which contains an oxetane group as an essential ingredient is preferable. Note that, “acrylic group” may also be a substituted acrylic group.

As specific examples of the carboxylic acid which has an acrylic group, a (meth)acrylic acid (meaning acrylic acid and/or methacrylic acid, below, same for methyl(meth)acrylate etc.), crotonic acid, maleic acid, fumaric acid, citraconic acid, mesaconic acid, glutaconic acid, or mono-(2-((meth)acryloyloxy)ethyl)phthalate, N-(carboxyphenyl)maleimide, N-(carboxyphenyl)(meth)acrylamide, etc. may be mentioned.

As specific examples of the carboxylic acid anhydride which has an acrylic group, anhydrous maleic acid, citraconic acid anhydride, etc. may be mentioned.

As specific examples of the acrylate compound which contains an epoxy group, glycidyl acrylate, glycidyl methacrylate, glycidyl α-ethylacrylate, glycidyl α-n-propylacrylate, glycidyl α-n-butylacrylate, 3,4-epoxybutyl acrylate, 3,4-epoxybutyl methacrylate, 6,7-epoxyheptyl acrylate, 6,7-epoxyheptyl methacrylate, 6,7-epoxyheptyl α-ethylacrylate, 3,4-epoxycyclohexylmethyl acrylate, 3,4-epoxycyclohexyl methyl methacrylate, etc. may be mentioned.

As specific examples of the acrylate compound which contains an oxetane group, (3-methyloxetan-3-yl)methyl (meth)acrylate, (3-ethyloxetan-3-yl)methyl (meth)acrylate, (3-methyloxetan-3-yl)ethyl (meth)acrylate, (3-ethyloxetan-3-yl)ethyl (meth)acrylate, (3-chloromethyloxetan-3-yl)methyl (meth)acrylate, (oxetan-2-yl)methyl (meth)acrylate, (2-methyloxetan-2-yl)methyl (meth)acrylate, (2-ethyloxetan-2-yl)methyl (meth)acrylate, (1-methyl-1-oxetanyl-2-phenyl)-3-(meth)acrylate, (1-methyl-1-oxetanyl)-2-trifluoromethyl-3-(meth)acrylate, and (1-methyl-1-oxetanyl)-4-trifluoromethyl-2-(meth)acrylate, etc. may be mentioned.

Among these, (meth)acrylic acid, anhydrous maleic acid, glycidyl (meth)acrylate, 6,7-epoxyheptyl methacrylate, etc. are preferable.

The acrylic resin (A2) may be a copolymer of at least one compound which is selected from an unsaturated carboxylic acid, unsaturated carboxylic acid anhydride, and epoxy-group containing unsaturated compound and another acrylate monomer or copolymerizable monomer other than acrylate.

As the other acrylate monomer, methyl (meth)acrylate, ethyl (meth)acrylate, propyl (meth)acrylate, isopropyl (meth)acrylate, butyl (meth)acrylate, isobutyl (meth)acrylate, t-butyl (meth)acrylate, amyl (meth)acrylate, isoamyl (meth)acrylate, hexyl (meth)acrylate, heptyl (meth)acrylate, octyl (meth)acrylate, isooctyl (meth)acrylate, ethylhexyl (meth)acrylate, nonyl (meth)acrylate, decyl (meth)acrylate, isodecyl (meth)acrylate, undecyl (meth)acrylate, dodecyl (meth)acrylate, lauryl (meth)acrylate, stearyl (meth)acrylate, isostearyl (meth)acrylate, or other alkyl (meth)acrylate; hydroxyethyl (meth)acrylate, 2-hydroxypropyl (meth)acrylate, 3-hydroxypropyl (meth)acrylate, 2-hydroxybutyl (meth)acrylate, 3-hydroxybutyl (meth)acrylate, 4-hydroxybutyl (meth)acrylate, or other hydroxyalkyl (meth)acrylate; phenoxyethyl (meth)acrylate, 2-hydroxy-3-phenoxypropyl (meth)acrylate, or other phenoxyalkyl (meth)acrylate; 2-methoxyethyl (meth)acrylate, 2-ethoxyethyl (meth)acrylate, 2-propoxyethyl (meth)acrylate, 2-butoxyethyl (meth)acrylate, 2-methoxybutyl (meth)acrylate, or other alkoxyalkyl (meth)acrylate; polyethyleneglycol mono(meth)acrylate, ethoxydiethyleneglycol (meth)acrylate, methoxypolyethyleneglycol (meth)acrylate, phenoxypolyethyleneglycol (meth)acrylate, nonylphenoxypolyethyleneglycol (meth)acrylate, polypropyleneglycol mono(meth)acrylate, methoxypolypropyleneglycol (meth)acrylate, ethoxypolypropyleneglycol (meth)acrylate, nonylphenoxypolypropyleneglycol (meth)acrylate, or other polyalkyleneglycol (meth)acrylate; cyclohexyl (meth)acrylate, 2-methylcyclohexyl (meth)acrylate, 4-butylcyclohexyl (meth)acrylate, 1-adamantyl (meth)acrylate, 2-methyl-2-adamantyl (meth)acrylate, 2-ethyl-2-adamantyl (meth)acrylate, tricyclo[5.2.1.0^{2,6}]decan-8-yl (meth)acrylate, tricyclo[5.2.1.0^{2,6}]-3-decen-8-yl (meth)acrylate, tricyclo[5.2.1.0^{2,6}]-3-decen-9-yl (meth)acrylate, bornyl (meth)acrylate, isobornyl (meth)acrylate, or other cycloalkyl (meth)acrylate; phenyl (meth)acrylate, naphthyl (meth)acrylate, biphenyl (meth)acrylate, benzyl (meth)acrylate, tetrahydrofurfuryl (meth)acrylate, 5-tetrahydrofurfuryl-oxycarbonylpentyl (meth)acrylate, vinyl (meth)acrylate, allyl (meth)acrylate, 2-(2-vinyloxyethoxy)ethyl (meth)acrylate, 2-[tricyclo[5.2.1.0^{2,6}]decan-8-yloxy]ethyl (meth)acrylate, 2-[tricyclo[5.2.1.0^{2,6}]-3-decen-8-yloxy]ethyl (meth)acrylate, 2-[tricyclo[5.2.1.0^{2,6}]-3-decen-9-yloxy]ethyl (meth)acrylate, γ-butyrolactone (meth)acrylate, maleimide, N-methylmaleimide, N-ethylmaleimide, N-butylmaleimide, N-cyclohexylmaleimide, N-benzylmaleimide, N-phenylmaleimide, N-(2,6-diethylphenyl)maleimide, N-(4-acetylphenyl)maleimide, N-(4-hydroxyphenyl)maleimide, N-(4-acetoxyphenyl)maleimide, N-(4-dimethylamino-3,5-dinitrophenyl)maleimide, N-(1-anilinonaphthyl-4)maleimide, N-[4-(2-benzoxazolyl)phenyl]maleimide, N-(9-acridinyl)maleimide, etc. may be mentioned.

Among these, methyl (meth)acrylate, butyl (meth)acrylate, cyclohexyl (meth)acrylate, 2-methylcyclohexyl (meth)acrylate, benzyl (meth)acrylate, tricyclo[5.2.1.0^{2,6}]decan-8-yl (meth)acrylate, N-phenylmaleimide, N-cyclohexyl maleimide, etc. are preferable.

The copolymerizable monomer other than acrylate is not particularly limited so long as a compound which is copolymerizable with the above carboxylic acid which has an acrylic group, carboxylic acid anhydride which has an acrylic group, or acrylate compound which contains an epoxy group, but for example vinyl benzylmethylether, vinyl glycidylether, styrene, α-methylstyrene, vinyltoluene, indene, vinylnaphthalene, vinylbiphenyl, chlorostyrene, bromostyrene, chloromethylstyrene, p-tert-butoxystyrene, p-hydroxystyrene, p-hydroxy-α-methylstyrene, p-acetoxystyrene, p-carboxystyrene, 4-hydroxyphenylvinylketone, acrylonitrile, methacrylonitrile, (meth)acrylamide, 1,2-epoxy-4-vinylcyclohexane, isobutene, norbornene, butadiene, isoprene, or other radical polymerizable compound may be mentioned.

These compounds may be used alone or may be used in combinations of two or more types.

The polymerization method of the above monomer may be one according to the ordinary method. For example, the suspension polymerization method, emulsion polymerization method, solution polymerization method, etc. are employed.

The polyimide (A3) used in the present invention can be obtained by heat treating a polyimide precursor which is obtained by reacting tetracarboxylic acid dianhydride and diamine. As the precursor for obtaining a polyimide, a polyamide acid, polyamide acid ester, polyisoimide, polyamide acid sulfonamide, etc. may be mentioned.

AB the acid dianhydride which can be used as a starting material for obtaining a polyimide (A3), specifically pyromellitic acid dianhydride, 3,3′,4,4′-biphenyltetracarboxylic acid dianhydride, 2,3,3′,4′-biphenyltetracarboxylic acid dianhydride, 2,2′,3,3′-biphenyltetracarboxylic acid dianhydride, 3,3′,4,4′-benzophenone tetracarboxylic acid dianhydride, 2,2′,3,3′-benzophenone tetracarboxylic acid dianhydride, 2,2-bis(3,4-dicarboxyphenyl)propane dianhydride, 2,2-bis(2,3-dicarboxyphenyl)propane dianhydride, 2,2-bis[3-[(3,4-dicarboxybenzoyl)amino]-4-hydroxyphenyl]hexafluoropropane dianhydride, 1,1-bis(3,4-dicarboxyphenyl)ethane dianhydride, 1,1-bis(2,3-dicarboxyphenyl)ethane dianhydride, bis(3,4-dicarboxyphenyl)methane dianhydride, bis(2,3-dicarboxyphenyl)methan dianhydride, bis(3,4-dicarboxyphenyl)sulfone dianhydride, bis(3,4-dicarboxyphenyl)ether dianhydride, 1,2,5,6-naphthalenetetracarboxylic acid dianhydride, 2,3,6,7-naphthalenetetracarboxylic acid dianhydride, 2,3,5,6-pyridinetetracarboxylic acid dianhydride, 3,4,9,10-perylene tetracarboxylic acid dianhydride, 2,2-bis(3,4-dicarboxyphenyl) hexafluoropropane dianhydride, or other aromatic tetracarboxylic acid dianhydride, 1,2,3,4-butane tetracarboxylic acid dianhydride, 1,2,3,4-cyclopentane tetracarboxylic acid dianhydride, or other aliphatic tetracarboxylic acid dianhydride, etc. may be mentioned. These acid dianhydrides may be used alone or in combinations of two or more types.

As specific examples of diamines which can be used as starting materials for obtaining a polyimide (A3), 3,4′-diaminodiphenylether, 4,4′-diaminodiphenylether, 3,4′-diaminodiphenylmethane, 4,4′-diaminodiphenylmethane, 3,4′-diaminodiphenylsulfone, 4,4′-diaminodiphenylsulfone, 3,4′-diaminodiphenylsulfide, 4,4′-diaminodiphenylsulfide, 1,4-bis(4-aminophenoxy)benzene, m-phenylenediamine, p-phenylenediamine, 1,5-naphthalenediamine, 2,6-naphthalenediamine, bis(4-aminophenoxyphenyl)sulfone, bis(3-aminophenoxyphenyl)sulfone, bis(4-aminophenoxy)biphenyl, bis{4-(4-aminophenoxy)phenyl}ether, 1,4-bis(4-aminophenoxy)benzene, 2,2′-dimethyl-4,4′-diaminobiphenyl, 2,2′-diethyl-4,4′-diaminobiphenyl, 3,3′-dimethyl-4,4′-diaminobiphenyl, 3,3′-diethyl-4,4′-diaminobiphenyl, 2,2′,3,3′-tetramethyl-4,4′-diaminobiphenyl, 3,3′,4,4′-tetramethyl-4,4′-diaminobiphenyl, 2,2′-di(trifluoromethyl)-4,4′-diaminobiphenyl; or these compounds with aromatic rings substituted by alkyl groups or halogen atoms; aliphatic cyclohexyldiamine, methylenebiscyclohexylamine, bis[(3-aminopropyl)dimethylsilyl]ether; 2,4-diaminobenzoic acid, 2,5-diaminobenzoic acid, 3,5-diaminobenzoic acid, 4,6-diamino-1,3-benzenedicarboxylic acid, 2,5-diamino-1,4-benzenedicarboxylic acid, bis(4-amino-3-carboxyphenyl)ether, bis(4-amino-3,5-dicarboxyphenyl) ether, bis(4-amino-3-carboxyphenyl)sulfone, bis(4-amino-3,5-dicarboxyphenyl)sulfone, 4,4′-diamino-3,3′-dicarboxybiphenyl, 4,4′-diamino-3,3′-dicarboxy-5,5′-dimethylbiphenyl, 4,4′-diamino-3,3′-dicarboxy-5,5′-dimethoxybiphenyl, 1,4-bis(4-amino-3-carboxyphenoxy)benzene, 1,3-bis(4-amino-3-carboxyphenoxy)benzene, bis[4-(4-amino-3-carboxyphenoxy)phenyl]sulfone, bis[4-(4-amino-3-carboxyphenoxy)phenyl]propane, 2,2-bis[4-(4-amino-3-carboxyphenoxy)phenyl]hexafluoro propane, or other diamine compound which has a carboxyl group; 2,4-diaminophenol, 3,5-diaminophenol, 2,5-diaminophenol, 4,6-diaminoresorcinol, 2,5-diaminohydroquinone, bis(3-amino-4-hydroxyphenyl)ether, bis(4-amino-3-hydroxyphenyl)ether, bis(4-amino-3,5-dihydroxyphenyl)ether, bis(3-amino-4-hydroxyphenyl)methane, bis(4-amino-3-hydroxyphenyl)methane, bis(4-amino-3,5-dihydroxyphenyl)methane, bis(3-amino-4-hydroxyphenyl)sulfone, bis(4-amino-3-hydroxyphenyl)sulfone, bis(4-amino-3,5-dihydroxyphenyl) sulfone, isophthalic acid bis(2-hydroxy-5-aminoanilide), 2-(4-aminobenzoylamino)-4-aminophenol, 2,2-bis(3-amino-4-hydroxyphenyl) hexafluoropropane, 2,2-bis(4-amino-3-hydroxyphenyl)hexafluoropropane, 2,2-bis(4-amino-3,5-dihydroxyphenyl)hexafluoro propane, 4,4′-diamino-3,3′-dihydroxybiphenyl, 4,4′-diamino-3,3′-dihydroxy-5,5′-dimethylbiphenyl, 4,4′-diamino-3,3′-dihydroxy-5,5′-dimethoxybiphenyl, 1,4-bis(3-amino-4-hydroxyphenoxy)benzene, 1,3-bis(3-amino-4-hydroxyphenoxy)benzene, 1,4-bis(4-amino-3-hydroxyphenoxy)benzene, 1,3-bis(4-amino-3-hydroxyphenoxy)benzene, bis[4-(3-amino-4-hydroxyphenoxy) phenyl]sulfone, bis[4-(3-amino-4-hydroxyphenoxy)phenyl]propane, 2,2-bis[4-(3-amino-4-hydroxyphenoxy)phenyl]hexafluoropropane, 2,2-bis[N-(2-hydroxy-5-aminophenyl)benzamide-4-yl]hexafluoropropane, 2,2-bis[3-[(3-aminobenzoyl)amino]-4-hydroxyphenyl]hexafluoropropane, 2,2-bis[3-[(4-aminobenzoyl)amino]-4-hydroxyphenyl]hexafluoropropane, or other diamine compound which has a phenolic hydroxyl group; 1,3-diamino-4-mercaptobenzene, 1,3-diamino-5-mercaptobenzene, 1,4-diamino-2-mercaptobenzene, bis(4-amino-3-mercaptophenyl)ether, 2,2-bis(3-amino-4-mercaptophenyl)hexafluoropropane, or other diamine compound which has a thiophenol group; 1,3-diaminobenzene-4-sulfonic acid, 1,3-diaminobenzene-5-sulfonic acid, 1,4-diaminobenzene-2-sulfonic acid, bis(4-aminobenzene-3-sulfonic acid)ether, 4,4′-diaminobiphenyl)3,3′-disulfonic acid, 4,4′-diamino-3,3′-dimethylbiphenyl-6,6′-disulfonic acid, or other diamine compound which has a sulfonic acid group; etc. may be mentioned. These diamines may be used alone or in combinations of two or more types.

The polyimide (A3) used in the present invention is synthesized by a known method. That is, it is synthesized by a known method such as selectively combining a tetracarboxylic acid dianhydride and diamine and reacting these in N-methyl-2-pyrrolidone, N,N-dimethylacetoamide, N,N-dimethylformamide, dimethylsulfoxide, hexamethylphosphotriamide, γ-butyrolactone, cyclopentanone, or other polar solvent.

When excessively using a diamine for polymerization, it is possible to react a carboxylic acid anhydride with the terminal amino group of the produced polyimide (A3) and protect the terminal amino group. Further, when excessively using a tetracarboxylic acid anhydride for polymerization, it is possible to react an amine compound with the terminal acid anhydride group of the produced polyimide (A3) and protect the terminal acid anhydride group.

As examples of such a carboxylic acid anhydride, phthalic acid anhydride, trimellitic acid anhydride, anhydrous maleic acid, naphthalic acid anhydride, hydrogenated phthalic acid anhydride, methyl-5-norbornene-2,3-dicarboxylic acid anhydride, anhydrous itaconic acid, tetrahydrophthalic acid anhydride, etc. may be mentioned, while as examples of an amine compound, aniline, 2-hydroxyaniline, 3-hydroxyaniline, 4-hydroxyaniline, 2-ethynylaniline, 3-ethynylaniline, 4-ethynylaniline, etc. may be mentioned.

The cardo resin (A4) used in the present invention is a resin which has a cardo structure, that is, a resin which has a backbone structure of quaternary carbon atom forming a cyclic structure to which two cyclic structures are bonded. A general cardo structure has benzene rings bonded to a fluorene ring.

As specific examples of the backbone structure of quaternary carbon atom forming a cyclic structure to which two cyclic structures are bonded, a fluorene backbone, bisphenol fluorene backbone, bisaminophenyl fluorene backbone, fluorene backbone which has an epoxy group, fluorene backbone which has an acrylic group, etc. may be mentioned.

The cardo resin (A4) used in the present invention is synthesized by polymerization by a reaction etc. between functional groups to which the backbones having cardo structures are bonded. A cardo resin (A4) has a structure where a main chain and bulk side chain are linked by single elements (cardo structure) and has a cyclic structure in a direction substantially vertical to the main chain.

As one example of a cardo structure, an example of a cardo structure to which an acryloyl group is bonded as a functional group is shown in the following formula (5).

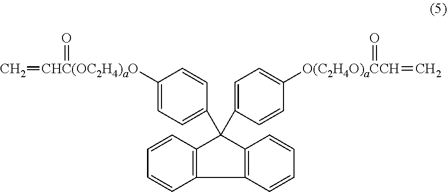

(where in the above formula (5), n is an integer of 0 to 10)

As a monomer which has a cardo structure, for example, a bis(glycidyloxyphenyl)fluorene type epoxy resin; a condensate of a bisphenolfluorene type epoxy resin and acrylic acid; 9,9-bis(4-hydroxyphenyl)fluorene, 9,9-bis(4-hydroxy-3-methylphenyl)fluorene, or other bis phenols which contain a cardo structure; 9,9-bis(cyanomethyl) fluorene, or other 9,9-bis(cyanoalkyl)fluorenes; 9,9-bis(3-aminopropyl) fluorene, or other 9,9-bis(aminoalkyl)fluorenes; etc. may be mentioned.

The cardo resin (A4) is a polymer which is obtained by polymerization of a monomer which has a cardo structure, but it may also be a copolymer with another copolymerizable monomer.

The polymerization method of the above monomer may be suitably selected in accordance with the type of the polymerizable functional group of the monomer. For example, the ring-opening polymerization method or addition polymerization method etc. is employed.

The polysiloxane (A5) used in the present invention is not particularly limited, but preferably a polymer which is obtained by mixing and reacting one or more organosilanes which are expressed by the following formula (6) may be mentioned.

(R⁶)ₘ—Si—(OR⁷)₄₋ₘ (6)

In the above formula (6), R⁶ is a hydrogen atom, C₁ to C₁₀ alkyl group, C₂ to C₁₀ alkenyl group, or C₆ to C₁₅ aryl group, where a plurality of R⁶ may be the same or different. Note that, these alkyl group, alkenyl group, and aryl group may also have substituent groups or may be nonsubstituents which have no substituent groups and may be selected in accordance with the characteristics of the composition. As specific examples of the alkyl group, a methyl group, ethyl group, n-propyl group, isopropyl group, n-butyl group, t-butyl group, n-hexyl group, n-decyl group, trifluoromethyl group, 2,2,2-trifluoroethyl group, 3,3,3-trifluoropropyl group, 3-glycidoxypropyl group, 2-(3,4-epoxycyclohexyl) ethyl group, 3-aminopropyl group, 3-mercaptopropyl group, or 3-isocyanate propyl group may be mentioned. As specific examples of the alkenyl group, a vinyl group, 3-acryloxypropyl group, or 3-methacryloxypropyl group may be mentioned. As specific examples of the aryl group, a phenyl group, tolyl group, p-hydroxyphenyl group, 1-(p-hydroxyphenyl)ethyl group, 2-(p-hydroxyphenyl)ethyl group, 4-hydroxy-5-(p-hydroxyphenylcarbonyloxy)pentyl group, or naphthyl group may be mentioned.

Further, in the above formula (6), R⁷ is a hydrogen atom, C₁ to C₆ alkyl group, C₁ to C₆ acyl group, or C₆ to C₁₅ aryl group, where a plurality of R⁷ may be the same or different. Note that, these alkyl group and acyl group may also have substituent groups or may be nonsubstituents which have no substituent groups and may be selected in accordance with the characteristics of the composition. As specific examples of the alkyl group, a methyl group, ethyl group, n-propyl group, isopropyl group, or n-butyl group may be mentioned. As specific examples of the acyl group, an acetyl group may be mentioned. As specific examples of the aryl group, a phenyl group may be mentioned.

Furthermore, in the above formula (6), m is an integer of 0 to 3, wherein when m=0, it is tetrafunctional silane, when m=1, it is trifunctional silane, when m=2, it is bifunctional silane, and when m=3, it is monofunctional silane.

As specific examples of the organosilane which is expressed by the above formula (6), tetramethoxysilane, tetraethoxysilane, tetraacetoxysilane, tetraphenoxysilane, and other tetrafunctional silanes; methyltrimethoxysilane, methyltriethoxysilane, methyltriisopropoxysilane, methyltri-n-butoxysilane, ethyltrimethoxysilane, ethyltriethoxysilane, ethyltriisopropoxysilane, ethyltri-n-butoxysilane, n-propyltrimethoxysilane, n-propyltriethoxysilane, n-butyltrimethoxysilane, n-butyltriethoxysilane, n-hexyltrimethoxysilane, n-hexyltriethoxysilane, decyltrimethoxysilane, vinyltrimethoxysilane, vinyltriethoxysilane, 3-methacryloxypropyltrimethoxysilane, 3-methacryloxypropyltriethoxysilane, 3-acryloxypropyltrimethoxysilane, phenyltrimethoxysilane, phenyltriethoxysilane, p-hydroxyphenyltrimethoxysilane, 1-(p-hydroxyphenyl)ethyltrimethoxysilane, 2-(p-hydroxyphenyl)ethyltrimethoxysilane, 4-hydroxy-5-(p-hydroxyphenylcarbonyloxy)pentyltrimethoxysilane, trifluoromethyltrimethoxysilane, trifluoromethyltriethoxysilane, 3,3,3-trifluoropropyltrimethoxysilane, 3-aminopropyltrimethoxysilane, 3-aminopropyltriethoxysilane, 3-glycidoxypropyltrimethoxysilane, 2-(3,4-epoxycyclohexyl)ethyltrimethoxysilane, 3-mercaptopropyltrimethoxysilane, and other trifunctional silanes; dimethyldimethoxysilane, dimethyldiethoxysilane, dimethyldiacetoxysilane, di-n-butyldimethoxysilane, diphenyldimethoxysilane, and other bifunctional silanes; and trimethylmethoxysilane, tri-n-butylethoxysilane, and other monofunctional silanes may be mentioned.

Among these organosilanes, from the viewpoint of the crack resistance and hardness of the obtained resin film, a trifunctional silane is preferably used. These organosilanes may be used alone or may be used in combinations of two or more types.

The polysiloxane (A5) used in the present invention is obtained by hydrolysis and partial condensation of the above-mentioned organosilanes. For the hydrolysis and partial condensation, general methods may be used. For example, the solvent, water, and if necessary a catalyst are added to the mixture in accordance with need and heated and stirred. During the stirring, it is also possible to distill off the hydrolysis byproducts (methanol and other alcohols) and condensation byproducts (water) in accordance with need by distillation.

The binder resin (A) used in the present invention has a weight average molecular weight (Mw) of usually 1,000 to 1,000,000, preferably 1,500 to 100,000, more preferably 2,000 to 10,000 in range.

Further, the molecular weight distribution of the binder resin (A) is the ratio of the weight average molecular weight/number average molecular weight (Mw/Mn) which is usually 4 or less, preferably 3 or less, more preferably 2.5 or less.

The weight average molecular weight (Mw) and the molecular weight distribution (Mw/Mn) of the binder resin (A) is a value which is found as a value converted to polystyrene by gel permeation chromatography (GPC) using tetrahydrofuran or another solvent as the eluent.

(Radiation-Sensitive Compound (B))

The radiation-sensitive compound (B) is a compound which undergoes a chemical reaction by irradiation by UV rays, electron beams, or other radiation. In the present invention, the radiation-sensitive compound (B) is preferably one which enables control of the alkali solubility of the resin film which is formed from a resin composition. In particular, use of a photoacid generator is preferable.

As such a radiation-sensitive compound (B), for example, an acetophenone compound, triarylsulfonium salt, quinone diazide compound, or other azide compound, etc. may be mentioned, but it is preferably an azide compound, particularly preferably a quinone diazide compound.

As the quinone diazide compound, for example, an ester compound of a quinone diazide sulfonic acid halide and compound which has a phenolic hydroxyl group can be used. As specific examples of a quinone diazide sulfonic acid halide, 1,2-naphthoquinonediazide-5-sulfonic acid chloride, 1,2-naphthoquinonediazide-4-sulfonic acid chloride, 1,2-benzoquinonediazide-5-sulfonic acid chloride, etc. may be mentioned. As typical examples of the compound which has a phenolic hydroxyl group, 1,1,3-tris(2,5-dimethyl-4-hydroxyphenyl)-3-phenylpropane, 4,4′-[1-[4-[1-[4-hydroxyphenyl]-1-methylethyl]phenyl]ethylidene]bisphenol, etc. may be mentioned. As other compounds which have phenolic hydroxyl groups, 2,3,4-trihydroxybenzophenone, 2,3,4,4′-tetrahydroxybenzophenone, 2-bis(4-hydroxyphenyl)propane, tris(4-hydroxyphenyl)methane, 1,1,1-tris(4-hydroxy-3-methylphenyl)ethane, 1,1,2,2-tetrakis(4-hydroxyphenyl)ethane, oligomer of a novolac resin, oligomer which is obtained by copolymerization of a compound which has at least one phenolic acid group and dicyclopentadiene, etc. may be mentioned.

Further, as a photoacid generator, in addition to a quinone diazide compound, an onium salt, halogenated organic compound, α,α′-bis(sulfonyl)diazomethane compound, α-carbonyl-α′-sulfonyldiazomethane compound, sulfone compound, organic acid ester compound, organic acid amide compound, organic acid imide compound, or other known one may be used.

These radiation-sensitive compounds may be used alone or in combination of two or more types.

In the resin composition of the present invention, the content of the radiation-sensitive compound (B) is preferably 20 to 100 parts by weight with respect to 10 parts by weight of the binder resin (A), more preferably 25 to 70 parts by weight, furthermore preferably 30 to 50 parts by weight. If the content of the radiation-sensitive compound (B) is in this range, it is possible to reduce the warping when baking the resin film which is obtained by using the resin composition of the present invention. Due to this, the obtained resin film can be made one with good surface conditions while making it one which is excellent in flatness, light resistance, and heat resistance.

(Silane-Modified Resin (C))

The silane-modified resin (C) used in the present invention has a resin part and silane compound part in a state where these are chemically bonded with each other.

The material which forms the resin part of the silane-modified resin (C) is not particularly limited, but a polymer material which has functional groups which can chemically bond with the silane compound part is preferable. Such a polymer material is not particularly limited, but for example a polyester, polyamide, polyimide, polyamic acid, epoxy resin, acrylic resin, urethane resin, phenol resin, etc. may be mentioned. Among these, due to the effect of the present invention becoming more remarkable, a polyamic acid, epoxy resin, acrylic resin, and phenol resin are preferable. Further, the functional group which can bond with the silane compound parts is not particularly limited, but for example a hydroxyl group, amino group, thiol group, carboxylic acid group, acid anhydride group, epoxy group, amide group, imide group, etc. may be mentioned. From the viewpoint of the reactivity with the silane compound part, a hydroxyl group, carboxylic acid group, or acid anhydride group is preferable.

The silicon compound which forms the silane compound part of the silane-modified resin (C) is not particularly limited, but for example a silicon compound which is expressed by the following formula (7) and/or a partially hydrolyzed condensate of the silicon compound which is expressed by the following formula (7) may be mentioned. From the viewpoint that the effect of the present invention becomes much more remarkable, in particular a silicon compound which is expressed by the following formula (8) which can be obtained by partial hydrolysis of the silicon compound which is shown in formula (7) is preferable.

(R⁸)ᵣ—Si—(OR⁹)₄₋ᵣ (7)

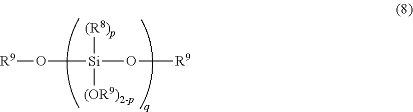

In the above formula (7), r is an integer of 0 to 3. R⁸ is a C₁ to C₁₀ alkyl group which may have a functional group which is directly bonded to a carbon atom, a C₆ to C₂₀ aryl group, or a C₂ to C₁₀ unsaturated aliphatic group. When there are a plurality of R⁸, the plurality of R⁸ may be the same or different. Further, R⁹ is a hydrogen atom or a C₁ to C₁₀ alkyl group which may have a functional group which is directly bonded to a carbon atom. When there are a plurality of R⁹, the plurality of R⁹ may be the same or different. Further, as the functional group which is directly bonded to a carbon atom which forms R⁸ and R⁹, a hydroxyl group, epoxy group, halogen group, mercapto group, carboxyl group, and methacryloxy group may be mentioned.

Further, in the above formula (8), p is 0 or 1. q is an integer of 2 to 10.

As specific examples of the C₁ to C₁₀ alkyl group which may have a functional group which is directly bonded to a carbon atom which forms R⁸ and R⁹, a methyl group, ethyl group, n-propyl group, i-propyl group, n-butyl group, i-butyl group, sec-butyl group, t-butyl group, n-pentyl group, i-pentyl group, sec-pentyl group, n-hexyl group, i-hexyl group, sec-hexyl group, cyclopentyl group, cyclohexyl group, cycloheptyl group, 3-chloropropyl group, 3-glycidoxypropyl group, epoxypropyl group, 3-methacryloxypropyl group, 3-mercaptopropyl group, 3,3,3-trifluoropropyl group, etc. may be mentioned.

As specific examples of the C₆ to C₂₀ aryl group which may have a functional group which is directly bonded to a carbon atom which forms R⁸, a phenyl group, toluoyl group, p-hydroxyphenyl group, 1-(p-hydroxyphenyl)ethyl group, 2-(p-hydroxyphenyl)ethyl group, 4-hydroxy-5-(p-hydroxyphenylcarbonyloxy)pentyl group, naphthyl group, etc. may be mentioned.

Further, specific examples of the C₁ to C₁₀ unsaturated aliphatic group which may have a functional group which is directly bonded to a carbon atom which forms R⁸, a vinyl group, 3-acryloxypropyl group, 3-methacryloxypropyl group, etc. may be mentioned.

As specific examples of such a silicon compound, tetramethoxysilane, tetraethoxysilane, tetrapropoxysilane, tetra-i-propoxysilane, tetrabutoxysilane, tetra-i-butoxysilane, methyltrimethoxysilane, ethyltrimethoxysilane, n-propyltrimethoxysilane, i-propyltrimethoxysilane, 3-chloropropyltrimethoxysilane, vinyltrimethoxysilane, phenyltrimethoxirane, methyltriethoxysilane, ethyltriethoxysilane, n-propyltriethoxysilane, i-propyltriethoxysilane, 3-chloropropyltriethoxysilane, vinyltriethoxysilane, phenyltriethoxirane, methyltri-i-propoxysilane, ethyltri-i-propoxysilane, n-propyltri-i -propoxysilane, i-propyltri-i-propoxysilane, 3-chloropropyltri-i -propoxysilane, vinyltri-i-propoxysilane, phenyltri-i-propoxysilane, methyltributoxysilane, ethyltributoxysilane, n-propyltributoxysilane, propyltributoxysilane, 3-chloropropyltributoxysilane, vinyltributoxysilane, phenyltributoxysilane, 3,3,3-trifluorotrimethoxysilane, 3-methacryloxypropyltrimethoxysilane, methyltriglycidoxysilane, 3-glycidoxypropyltrimethoxysilane, 3-mercaptopropyltrimethoxysilane, 3,4-epoxycyclohexyltrimethoxysilane, 3,3,3-trifluorotriethoxysilane, 3-methacryloxypropyltriethoxysilane, 3-glycidoxypropyltriethoxysilane, 3-mercaptopropyltriethoxysilane, 3,4-epoxycyclohexyltriethoxysilane, 3,3,3-trifluorotri-i-propoxysilane, 3-methacryloxypropyltri-i-propoxysilane, 3-glycidoxypropyltri-i-propoxysilane, 3-mercaptopropyltri-i-propoxysilane, 3,4-epoxycyclohexyltri-i-propoxysilane, 3,3,3-trifluorotributoxysilane, 3-methacryloxypropyltributoxysilane, 3-glycidoxypropyltributoxysilane, 3-mercaptopropyltributoxysilane, 3,4-epoxycyclohexyltributoxysilane, dimethyldimethoxysilane, dimethyldiethoxysilane, diethyldimethoxysilane, diethyldiethoxysilane, diphenyldimethoxysilane, diphenyldiethoxysilane, etc. may be mentioned. These are preferably used as partially hydrolyzed condensates. These may be used alone as single types or jointly as two or more types.

Further, when the silane compound part is a partially hydrolyzed condensate of a silicon compound, the above-mentioned partial condensate which is obtained by partial hydrolysis of a silicon compound may be used as it is. Alternatively, it is possible to use part of the obtained partial condensate which is substituted by a dealcoholization reaction using an alcohol which has an epoxy group, halogen group, mercapto group, carboxyl group, methacryloxy group, or other functional group. By substituting the partial condensate which is obtained by partial hydrolysis of the above-mentioned silicon compound by using alcohol which has such functional groups, it is possible to simply obtain a partial hydrolyzed condensate which has such functional groups.

The method of chemically bonding the above-mentioned resin part and silane compound part to obtain a silane-modified resin (C) is not particularly limited, but for example the method of using a polymer material which has a hydroxyl group for the resin part and causing a dealcoholization reaction with the alkoxyl group of the silane compound part so as to chemically bond the resin part and silane compound part may be mentioned. Alternatively, the method of using a polymer material which has a carboxylic acid group or acid anhydride group for the resin part, using a compound which has a glycidyloxy group for the silane compound part, and causing an addition reaction of these, the method of opening the oxirane ring and causing a ring-opening esterification reaction, etc. may be mentioned. Further, by polymerizing the resin part after chemically bonding the resin part and the silane compound part, it is possible to increase the molecular weight of the resin part. Note that, in this case, it is possible to use a low molecular weight organic material as the material for chemically bonding with the silane compound parts and possible to employ the method of polymerizing the low molecular weight organic material to increase the molecular weight after chemically bonding the low molecular weight organic material and silane compound part.

For example, in the above method, according to the dealcoholization reaction, it is possible to obtain the silane-nodified resin (C) by charging the material which forms the resin part and the material which forms the silane compound part, heating them, and distilling off the produced alcohol while performing an ester exchange reaction. The reaction temperature is usually 70 to 150° C., preferably 80 to 130° C., while the total reaction time is usually 2 to 15 hours. If the reaction temperature is too low, the alcohol cannot be efficiently distilled off. Further, if the reaction temperature is too high, sometimes curing condensation of the material which forms the silane compound part ends up starting.

Further, at the time of the above dealcoholization reaction, to promote the reaction, it is possible to use a conventionally known ester exchange catalyst of an ester and hydroxyl group. As the ester exchange catalyst, for example, acetic acid, p-toluenesulfonic acid, benzoic acid, propionic acid, or other organic acid or lithium, sodium, potassium, rubidium, cesium, magnesium, calcium, barium, strontium, zinc, aluminum, titanium, cobalt, germanium, tin, lead, antimony, arsenic, cerium, boron, cadmium, manganese, or other such metal, these oxides, organic acid salts, halides, alkoxides, etc. may be mentioned. Among these as well, it is preferable to use an organic acid salt of a metal and an organic acid, while organic tin and organic acid tin are particularly preferable. Specifically, acetic acid, tin octylate, and dibutyltin dilaurate are preferable.

Further, the dealcoholization reaction can be performed in an organic solvent or without a solvent. The organic solvent is not particularly limited so long as an organic solvent which dissolves the material which forms the resin part and the material which forms the silane compound part, but for example it is preferable to use dimethylformamide, dimethylacetoamide, methylethylketone, cyclohexanone, diethyleneglycol methylethylether, or other aprotonic polar solvent with a boiling point of 75° C. or more.

Alternatively, in the above method, it is possible to obtain a silane-modified resin (C) according to the ring-opening esterification reaction by charging the material which forms the resin part and the material which forms the silane compound part and heating them to cause a ring-opening esterification reaction. The reaction temperature is usually 40 to 130° C., preferably 70 to 110° C., while the total reaction time is usually 1 to 7 hours. If the reaction temperature is too low, the reaction time becomes longer. Further, if the reaction temperature is too high, sometimes curing condensation of the material which forms the silane compound part ends up starting.

In the ring-opening esterification reaction, it is possible to use a catalyst for promoting the reaction. As the catalyst, for example, 1,8-diaza-bicyclo[5.4.0]-7-undecene, triethylenediamine, benzyldimethylamine, triethanolamine, dimethylaminoethanol, tris(dimethylaminomethyl)phenol, or other tertiary amines; 2-methylimidazole, 2-phenylimidazole, 2-phenyl-4-methylimidazole, 2-heptadecylimidazole, benzimidazole, or other imidazoles; tributylphosphine, methyldiphenylphosphine, triphenylphosphine, diphenylphosphine, phenylphosphine, or other organic phosphines; tetraphenylphosphonium-tetraphenylborate, 2-ethyl-4-methylimidazole-tetraphenylborate, N-methylmorpholine-tetraphenylborate, or other tetraphenylboron salts etc. may be mentioned.

Further, the ring-opening esterification reaction is preferably performed in the presence of an organic solvent. The organic solvent is not particularly limited so long as it is an organic solvent which dissolves the material which forms the resin part and the material which forms the silane compound part, but for example N-methyl-2-pyrrolidone, dimethylformamide, dimethylacetoamide, or cyclohexanone, etc. may be used.

The ratio of the resin part and silane compound part of the silane-modified resin (C) used in the present invention is a weight ratio of the “resin part:silane compound part” of preferably 1:50 to 50:1, more preferably 1:10 to 10:1. By making the ratio of the resin part and the silane compound part the above range, the effect of the present invention becomes much more remarkable, so is preferable.

The content of the silane-modified resin (C) in the resin composition of the present invention is 0.1 to 150 parts by weight with respect to 100 parts by weight of the binder resin (A), preferably 1 to 100 parts by weight, more preferably 2 to 50 parts by weight, furthermore preferably 5 to 40 parts by weight. If the content of the silane-modified resin (C) is too small, the warping at the time of baking the resin film which is obtained using the resin composition of the present invention is liable to become larger and the heat resistance to become poor. On the other hand, if too large, the obtained resin film is liable to deteriorate in surface conditions and flatness and to fall in transparency.

(Antioxidant (D))

The antioxidant (D) is not particularly limited, but for example one which is used for usual polymers such as a phenol-based antioxidant, phosphorus-based antioxidant, sulfur-based antioxidant, amine-based antioxidant, lactone-based antioxidant, etc. may be used.

As a phenol-based antioxidant, a conventionally known one may be used. For example, 2-t-butyl-6-(3-t-butyl-2-hydroxy-5-methylbenzyl)-4-methylphenylacrylate, 2,4-di-t-amyl-6-[1-(3,5-di-t-amyl-2-hydroxyphenyl)ethyl]phenylacrylate, or other acrylate-based compounds which are described in Japanese Patent Publication No. 63-179953A or Japanese Patent Publication No. 1-168643A; 2,6-di-t-butyl-4-methylphenol, 2,6-di-t-butyl-4-ethylphenol, octadecyl-3-(3,5-di-t-butyl-4-hydroxyphenyl)propionate, 2,2′-methylene-bis(4-methyl-6-t-butylphenol), 4,4′-butylidene-bis(6-t-butyl-m-cresol), 4,4′-thiobis(3-methyl-6-t-butylphenol), bis(3-cyclohexyl-2-hydroxy-5-methylphenyl)methane, 3,9-bis[2-[3-(3-t-butyl-4-hydroxy-5-methylphenyl)propionyloxy]-1,1-dimethylethyl]-2,4,8,10-tetraoxaspiro[5,5]undecane, 1,1,3-tris(2-methyl-4-hydroxy-5-t-butylphenyl)butane, pentaerythritol tetrakis[3-(3′,5′-di-tert-butyl-4′-hydroxyphenyl)propionate], triethyleneglycol bis[3-(3-t-butyl-4-hydroxy-5-methylphenyl)propionate], tocopherol, or other alkyl-substituted phenol-based compounds; 6-(4-hydroxy-3,5-di-t-butylanilino)-2,4-bis-octylthio-1,3,5-triazine, 6-(4-hydroxy-3,5-dimethylanilino)-2,4-bis-octylthio-1,3,5-triazine, 6-(4-hydroxy-3-methyl-5-t-butylanilino)-2,4-bis-octylthio-1,3,5-triazine, 2-octylthio-4,6-bis-(3,5-di-t-butyl-4-oxyanilino)-1,3,5-triazine, or other triazine-group containing phenol-based compound; etc. may be used.

The phosphorus-based antioxidant is not particular limited so long as being one which is usually used in the general resin industry. For example, triphenylphosphite, diphenylisodecylphosphite, phenyldiisodecylphosphite, tris(nonylphenyl)phosphite, tris(dinonylphenyl)phosphite, tris(2,4-di-t-butylphenyl)phosphite, tris(2-t-butyl-4-methylphenyl)phosphite, tris(cyclohexylphenyl)phosphite, 2,2′-methylenebis(4,6-di-t-butylphenyl)octylphosphite, 9,10-dihydro-9-oxa-10-phosphaphenanthren-10-oxide, 10-(3,5-di-t-butyl-4-hydroxybenzyl)-9,10-dihydro-9-oxa-10-phosphaphenanthren-10-oxide, 10-decyloxy-9,10-dihydro-9-oxa-10-phosphaphenanthrene, and other monophosphite-based compounds; 4,4′-butylidene-bis(3-methyl-6-t-butylphenyl-di-tridecylphosphite), 4,4′-isopropylidene-bis[phenyl-di-alkyl(C₁₂ to C₁₅)phosphite], 4,4′-isopropylidene-bis[diphenylmonoalkyl(C₁₂ to C₁₅)phosphite], 1,1,3-tris(2-methyl-4-di-tridecylphosphite-5-t-butylphenyl)butane, tetrakis(2,4-di-t-butylphenyl)-4,4′-biphenylenediphosphite, cyclic neopentanetetraylbis(octadecylphosphite), cyclic neopentanetetraylbis(isodecylphosphite), cyclic neopentanetetraylbis(nonylphenylphosphite), cyclic neopentanetetraylbis(2,4-di-t-butylphenylphosphite), cyclic neopentanetetraylbis(2,4-dimethylphenylphosphite), cyclic neopentanetetraylbis(2,6-di-t-butylphenylphosphite), or other diphosphite-based compound etc. may be used. Among these as well, a monophosphite-based compound is preferable, while tris(nonylphenyl) phosphite, tris(dinonylphenyl)phosphite, tris(2,4-di-t-butylphenyl) phosphite, etc. are particularly preferable.

As the sulfur-based antioxidant, for example, dilauryl-3,3′-thiodipropionate, dimyristyl-3,3′-thiodipropionate, distearyl-3,3′-thiodipropionate, laurylstearyl-3,3′-thiodipropionate, pentaerythritol-tetrakis-(β-laurylthiopropionate), 3,9-bis(2-dodecylthioethyl)-2,4,8,10-tetraoxaspiro[5,5]undecane, etc. may be used.

Among these as well, a phenol-based antioxidant is preferable. Among these, pentaerythritol tetrakis[3-(3′,5′-di-tert-butyl-4′-hydroxyphenyl)propionate] is more preferable.

These antioxidants (D) may be used alone or in combinations of two or more types.

In the present invention, by adding an antioxidant (D) to the resin composition, it is possible to improve the light resistance and heat resistance at the time of making the resin film. In the resin composition of the present invention, the content of the antioxidant (D) is 0.1 to 10 parts by weight with respect to 100 parts by weight of the binder resin (A), preferably 1 to 5 parts by weight. If the content of the antioxidant (D) is in the above range, the obtained resin film can be made excellent in light resistance and heat resistance.

(Cross-Linking Agent (E))

Also, the resin composition of the present invention may further contain a cross-linking agent (E). The cross-linking agent (E) used in the present invention is one which forms a cross-linked structure between cross-linking agent molecules by heating or one which forms a cross-linked structure between resin molecules by reaction with the binder resin (A). Specifically, a compound which has two or more reactive groups may be mentioned. As such reactive groups, for example, an amino group, carboxy group, hydroxyl group, epoxy group, or isocyanate group may be mentioned. More preferably, there is an amino group, epoxy group, and isocyanate group. An amino group and epoxy group are particularly preferable.

The molecular weight of the cross-linking agent (E) is not particularly limited, but usually is 100 to 100,000, preferably 300 to 50,000, more preferably 500 to 10,000. The cross-linking agent may be used alone or as two or more types in combination.

As specific examples of the cross-linking agent (E), hexamethylenediamine or other aliphatic polyamines; 4,4′-diaminodiphenylether, diaminodiphenylsulfone, or other aromatic polyamines; 2,6-bis(4′-azidobenzal)cyclohexanone, 4,4′-diazidodiphenylsulfone, or other azides; nylon, polyhexamethylenediamine terephthalamide, polyhexamethylene isophthalamide, or other polyamides; N,N,N′,N′,N″,N″-(hexaalkoxyalkyl)melamine or other melamines which may have methylol groups or imino groups etc. (product name “Cymel 303, Cymel 325, Cymel 370, Cymel 232, Cymel 235, Cymel 272, Cymel 212, Mycoat 506” (the above made by Cytec Industries) or other products of Cymel series or Mycoat series); N,N′,N″,N′″-(tetraalkoxyalkyl)glycoluril, or other glycolurils which may have methylol groups or imino groups etc. (product name “Cymel 1170” (the above made by Cytec Industries) or other products of the Cymel series); ethyleneglycol di(meth)acrylate, or other acrylate compounds; hexamethylene diisocyanate-based polyisocyanates, isophorone diisocyanate-based polyisocyanates, tolylene diisocyanate-based polyisocyanates, hydrated diphenylmethane diisocyanate, or other isocyanate-based compounds; 1,4-di-(hydroxymethyl)cyclohexane, 1,4-di-(hydroxymethyl)norbornane; 1,3,4-trihydroxycyclohexane; bisphenol A type epoxy resins, bisphenol F type epoxy resins, phenol novolac type epoxy resins, cresol novolac type epoxy resins, polyphenol type epoxy resins, cyclic aliphatic epoxy resins, aliphatic glycidyl ethers, epoxyacrylate polymers, or other epoxy compounds; may be mentioned.

As specific examples of epoxy compounds, a trifunctional epoxy compound which has a dicyclopentadiene backbone (product name “XD-1000”, made by Nippon Kayaku), 1,2-epoxy-4-(2-oxiranyl)cyclohexane adduct of 2,2-bis(hydroxymethyl)1-butanol (15-functional alicyclic epoxy resin which has a cyclohexane backbone and terminal epoxy groups, product name “EHPE3150”, made by Daicel Corporation), epoxylated 3-cyclohexene-1,2-dicarboxylic acid bis(3-cyclohexenylmethyl)-modified ε-caprolactone (aliphatic cyclic trifunctional epoxy resin, product name “Epolead GT301”, made by Daicel Corporation), epoxylated butanetetracarboxylic acid tetrakis(3-cyclohexenylmethyl)-modified ε-caprolactone (aliphatic cyclic tetrafunctional epoxy resin, product name “Epolead GT401”, made by Daicel Corporation), 3,4-epoxycyclohexenylmethyl-3′,4′-epoxycyclohexenecarboxylate (product name “Celloxide 2021”, made by Daicel Corporation), 1,2:8,9-diepoxy limonene (product name “Celloxide 3000”, made by Daicel Corporation), 2-(3,4-epoxycyclohexyl) ethyltrimethoxysilane (product name “Z-6043”, made by Toray-Dow Corning), or other epoxy compound which has an alicyclic structure;

an aromatic amine type polyfunctional epoxy compound (product name “H-434”, made by Tohto Kasei), tris(2,3-epoxypropyl)isocyanulate (polyfunctional epoxy compound which has triazine backbone, product name “TEPIC”, made by Nissan Chemical Industries), cresol novolac type polyfunctional epoxy compound (product name “EOCN-1020”, made by Nippon Kayaku), phenol novolac type polyfunctional epoxy compound (Epicoat 152, 154, Japan Epoxy Resin), polyfunctional epoxy compound which has a naphthalene backbone (product name EXA-4700, made by DIC), chain alkyl polyfunctional epoxy compound (product name “SR-TMP”, made by Sakamoto Yakuhin Kogyo), polyfunctional epoxypolybutadiene (product name “Epolead PB3600”, made by Daicel Corporation), glycidylpolyether compound of glycerin (product name “SR-GLG”, made by Sakamoto Yakuhin Kogyo), diglycerin polyglycidylether compound (product name “SR-DGE”, made by Sakamoto Yakuhin Kogyo, polyglycerin polyglycidylether compound (product name “SR-4GL”, made by Sakamoto Yakuhin Kogyo), glycidoxypropyltrimethyl silane (product name “Z-6040”, made by Toray-Dow Corning), or other epoxy compound which does not have an alicyclic structure; may be mentioned.

In the resin composition of the present invention, the content of the cross-linking agent (E) is not particularly limited. It may be freely set considering the extent of the heat resistance which is sought from the resin film which is obtained using the resin composition of the present invention, but it is usually 5 to 80 parts by weight with respect to 100 parts by weight of the binder resin (A), preferably 20 to 75 parts by weight, more preferably 25 to 70 parts by weight. If the cross-linking agent (E) is too great or too small, the heat resistance tends to fall.

(Other Compounding Agents)

The resin composition of the present invention may further contain a solvent. The solvent is not particularly limited. One known as a solvent of a resin composition, for example, acetone, methylethylketone, cyclopentanone, 2-hexanone, 3-hexanone, 2-heptanone, 3-heptanone, 4-heptanone, 2-octanone, 3-octanone, 4-octanone, or other linear ketones; n-propyl alcohol, isopropyl alcohol, n-butyl alcohol, cyclohexanol, or other alcohols; ethyleneglycol dimethylether, ethyleneglycol diethylether, dioxane, or other ethers; ethyleneglycol monomethylether, ethyleneglycol monoethylether, or other alcohol ethers; propyl formate, butyl formate, propyl acetate, butyl acetate, methyl propionate, ethyl propionate, methyl butyrate, ethyl butyrate, methyl lactate, ethyl lactate, and other esters; cellosolve acetate, methylcellosolve acetate, ethylcellosolve acetate, propylcellosolve acetate, butylcellosolve acetate, or other cellosolve esters; propyleneglycol, propyleneglycol monomethylether, propyleneglycol monomethylether acetate, propyleneglycol monoethylether acetate, propyleneglycol monobutylether, or other propyleneglycols; diethyleneglycol monomethylether, diethyleneglycol monoethylether, diethyleneglycol dimethylether, diethyleneglycol diethylether, diethyleneglycol methylethylether, or other diethyleneglycols; γ-butyrolactone, γ-valerolactone, γ-caprolactone, γ-caprylolactone, and other saturated γ-lactones; trichloroethylene and other halogenated hydrocarbons; toluene, xylene, and other aromatic hydrocarbons; dimethylacetoamide, dimethylformamide, N-methylacetoamide, and polar solvents etc. may be mentioned. These solvents may be used alone or in combinations of two or more types. The content of the solvent is preferably 10 to 10000 parts by weight with respect to 100 parts by weight of the binder resin (A), more preferably 50 to 5000 parts by weight, furthermore preferably 100 to 1000 parts by weight in range. Note that, when including a solvent in the resin composition, the solvent is usually removed after the formation of the resin film.

Further, the resin composition of the present invention may include, within a range in which the effect of the present invention is not inhibited, as desired a surfactant, a compound which has an acidic group or thermally latent acidic group, coupling agent or its derivative, sensitizer, photostabilizer, defoamer, pigment, dye, filler, or other compounding agent; etc.

The surfactant is used for the purpose of prevention of striation, improvement of the development ability, etc.

As the surfactant, for example, a silicone-based surfactant, fluorine-based surfactant, polyoxyalkylene-based surfactant, methacrylic acid copolymer-based surfactant, acrylic acid copolymer-based surfactant, etc. may be mentioned.

As the silicone-based surfactant, for example, “SH28PA”, “SH29PA”, “SH30PA”, “ST80PA”, “ST83PA”, “ST86PA”, “SF8416”, “SH203”, “SH230”, “SF8419”, “SF8422”, “FS1265”, “SH510”, “SH550”, “SH710”, “SH8400”, “SF8410”, “SH8700”, and “SF8427” (above made by Toray-Dow Corning), product name “KP-321”, “KP-323”, “KP-324”, “KP-340”, and “KP-341” (above made by Shin-Etsu Chemical), product name “TSF400”, “TSF401”, “TSF410”, “TSF4440”, “TSF4445”, “TSF4450”, “TSF4446”, “TSF4452”, and “TSF4460” (above made by Momentive Performance Materials Japan), product name “BYK300”, “BYK301”, “BYK302”, “BYK306”, “BYK307”, “BYK310”, “BYK315”, “BYK320”, “BYK322”, “BYK323”, “BYK331”, “BYK333”, “BYK370”, “BYK375”, “BYK377”, and “BYK378” (above made by BYK Additive and Instruments Japan), etc. may be mentioned.

As the fluorine-based surfactant, for example, Fluorinate “FC-430”, “FC-431” (above made by Sumitomo 3M), Surflon “S-141”, “S-145”, “S-381”, and “S-393” (above made by Asahi Glass), f-top (Registered Trademark) “EF301”, “EF303”, “EF351”, and “EF352” (above made by JEMCO), Megafac (Registered Trademark) “F171”, “F172”, “F173”, “R-30” (above made by DIC Corporation), etc. may be mentioned.

As the polyoxyalkylene-based surfactant, for example, polyoxyethylene laurylether, polyoxyethylene stearylether, polyoxyethylene oleylether, polyoxyethylene octylphenylether, polyoxyethylene nonylphenylether, or other polyoxyethylene alkylethers, polyethyleneglycol dilaurate, polyethyleneglycol distearate, or other polyoxyethylene dialkylesters, etc. may be mentioned.

These surfactants may be used alone or in combination of two or more types.

The compound which has the acidic group or thermally latent acidic group is not particularly limited so long as having an acidic group or a thermally latent acidic group which forms an acidic group upon being heated, but is preferably an aliphatic compound, aromatic compound, heterocyclic compound, furthermore preferably an aromatic compound or heterocyclic compound.

These acidic groups or compounds which have a thermally latent acidity may be used alone or in combinations of two or more types.

The number of the acidic groups and thermally latent acidic groups of the compound which has acidic groups or thermally latent acidic groups is not particularly limited, but a compound which has a total of two or more acidic groups and/or thermally latent acid groups is preferable. The acidic groups or thermally latent acidic groups may be the same or different.

The acidic groups may be acidic functional groups. As specific examples, sulfonic acid groups, phosphoric acid groups, or other strongly acidic groups; carboxy groups, thiol groups, carboxymethylenethio groups, or other weakly acidic groups; may be mentioned. Among these as well, a carboxy group, thiol group, or carboxymethylenethio group is preferable, while a carboxy group is particularly preferable. Further, among these acidic groups as well, ones with acid dissociation constants pKa in the range of 3.5 to 5.0 are preferable. Note that, when there are two or more acidic groups, the first dissociation constant pKa1 is made the acid dissociation constant, and the first dissociation constant pKa1 is preferably in the above range. Further, pKa is found by measuring the acid dissociation constant Ka=[H₃O⁺][B⁻]/[BH] under dilute aqueous solution conditions and processing by pKa=−log Ka. Here, BH indicates the organic acid, while B⁻ indicates the conjugated base of the organic acid.

Note that, the method of measurement of pKa can, for example, be use of a pH meter for measurement of the concentration of hydrogen ions and calculation from the concentration of the substance and the concentration of the hydrogen ions.

Further, the thermally latent acidic group may be a group which produces an acidic functional group upon being heated. As specific examples, a sulfonium salt group, benzothiazolium salt group, ammonium salt group, phosphonium salt group, block carboxylic acid group, etc. may be mentioned. Among these, a block carboxylic acid group is preferable. Note that, the blocking agent of the carboxy group which is used for obtaining a block carboxylic acid group is not particularly limited, but a vinyl ether compound is preferable.

Further, the compound which has an acidic group or a thermally latent acidic group may have a substituent group other than an acidic group or a thermally latent acidic group.

AB such a substituent group, in addition to an alkyl group, aryl group, or other hydrocarbon group, a halogen atom; alkoxy group, aryloxy group, acyloxy group, heterocyclic oxy group; amino group which is substituted by an alkyl group or aryl group or heterocyclic group, acylamino group, ureido group, sulfamoylamino group, alkoxycarbonylamino group, or aryloxycarbonylamino group; alkylthio group, arylthio group, heterocyclic thio group; or other polar group which does not have a proton, hydrocarbon group which is substituted by a polar group which does not have a proton, etc. may be mentioned.

Among the compounds which have such an acidic group or thermally latent acidic group, as specific examples of a compound which has an acidic group, methane acid, ethane acid, propane acid, butane acid, pentane acid, butane acid, pentane acid, hexane acid, heptane acid, octane acid, nonane acid, decane acid, glycol acid, glycerin acid, ethane diacid (also referred to as “oxalic acid”), propane diacid (also referred to as “malonic acid”), butane diacid (also referred to as “succinic acid”), pentane diacid, hexane diacid (also referred to as “adipic acid”), 1,2-cyclohexane dicarboxylic acid, 2-oxopropanic acid, 2-hydroxybutane diacid, 2-hydroxy propanetricarboxylic acid, mercaptosuccinic acid, dimercaptosuccinic acid, 2,3-dimercapto-1-propanol, 1,2,3-trimercaptopropane, 2,3,4-trimercapto-1-butanol, 2,4-dimercapto-1,3-butanediol, 1,3,4-trimercapto-2-butanol, 3,4-dimercapto-1,2-butanediol, 1,5-dimercapto-3-thiapentane, or other aliphatic compound;

benzoic acid, p-hydroxybenzenecarboxylic acid, o-hydroxybenzenecarboxylic acid, 2-naphthalenecarboxylic acid, methylbenzoic acid, dimethylbenzoic acid, trimethylbenzoic acid, 3-phenylpropane acid, dihydroxybenzoic acid, dimethoxybenzoic acid, benzene-1,2-dicarboxylic acid (also referred to as “phthalic acid”), benzene-1,3-dicarboxylic acid (also referred to as “isophthalic acid”), benzene-1,4-dicarboxylic acid (also referred to as “terephthalic acid”), benzene-1,2,3-tricarboxylic acid, benzene-1,2,4-tricarboxylic acid, benzene-1,3,5-tricarboxylic acid, benzenehexacarboxylic acid, biphenyl-2,2′-dicarboxylic acid, 2-(carboxymethyl)benzoic acid, 3-(carboxymethyl)benzoic acid, 4-(carboxymethyl)benzoic acid, 2-(carboxycarbonyl)benzoic acid, 3-(carboxycarbonyl)benzoic acid, 4-(carboxycarbonyl)benzoic acid, 2-mercaptobenzoic acid, 4-mercaptobenzoic acid, diphenol acid, 2-mercapto-6-naphthalenecarboxylic acid, 2-mercapto-7-naphthalenecarboxylic acid, 1,2-dimercaptobenzene, 1,3-dimercaptobenzene, 1,4-dimercaptobenzene, 1,4-naphthalenedithiol, 1,5-naphthalenedithiol, 2,6-naphthalenedithiol, 2,7-naphthalenedithiol, 1,2,3-trimercaptobenzene, 1,2,4-trimercaptobenzene, 1,3,5-trimercaptobenzene, 1,2,3-tris(mercaptomethyl)benzene, 1,2,4-tris(mercaptomethyl)benzene, 1,3,5-tris(mercaptomethyl)benzene, 1,2,3-tris(mercaptoethyl)benzene, 1,2,4-tris(mercaptoethyl)benzene, 1,3,5-tris(mercaptoethyl)benzene, or other aromatic compound;

nicotinic acid, isonicotinic acid, 2-furoic acid, pyrrole-2,3-dicarboxylic acid, pyrrole-2,4-dicarboxylic acid, pyrrole-2,5-dicarboxylic acid, pyrrole-3,4-dicarboxylic acid, imidazole-2,4-dicarboxylic acid, imidazole-2,5-dicarboxylic acid, imidazole-4,5-dicarboxylic acid, pyrazole-3,4-dicarboxylic acid, pyrazole-3,5-dicarboxylic acid, or other five-member heterocyclic compound which contains nitrogen atoms; thiophen-2,3-dicarboxylic acid, thiophen-2,4-dicarboxylic acid, thiophen-2,5-dicarboxylic acid, thiophen-3,4-dicarboxylic acid, thiazole-2,4-dicarboxylic acid, thiazole-2,5-dicarboxylic acid, thiazole-4,5-dicarboxylic acid, isothiazole-3,4-dicarboxylic acid, isothiazole-3,5-dicarboxylic acid, 1,2,4-thiadiazole-2,5-dicarboxylic acid, 1,3,4-thiadiazole-2,5-dicarboxylic acid, 3-amino-5-mercapto-1,2,4-thiadiazole, 2-amino-5-mercapto-1,3,4-thiadiazole, 3,5-dimercapto-1,2,4-thiadiazole, 2,5-dimercapto-1,3,4-thiadiazole, 3-(5-mercapto-1,2,4-thiadiazol-3-ylsulfanyl)succinic acid, 2-(5-mercapto-1,3,4-thiadiazol-2-ylsulfanyl)succinic acid, (5-mercapto-1,2,4-thiadiazol-3-ylthio)acetic acid, (5-mercapto-1,3,4-thiadiazol-2-ylthio)acetic acid, 3-(5-mercapto-1,2,4-thiadiazol-3-ylthio)propionic acid, 2-(5-mercapto-1,3,4-thiadiazol-2-ylthio)propionic acid, 3-(5-mercapto-1,2,4-thiadiazol-3-ylthio)succinic acid, 2-(5-mercapto-1,3,4-thiadiazol-2-ylthio)succinic acid, 4-(3-mercapto-1,2,4-thiadiazol-5-yl)thiobutanesulfonic acid, 4-(2-mercapto-1,3,4-thiadiazol-5-yl)thiobutanesulfonic acid, or other five-member heterocyclic compound which contains nitrogen atoms and sulfur atoms;

pyridine-2,3-dicarboxylic acid, pyridine-2,4-dicarboxylic acid, pyridine-2,5-dicarboxylic acid, pyridine-2,6-dicarboxylic acid, pyridine-3,4-dicarboxylic acid, pyridine-3,5-dicarboxylic acid, pyridazine-3,4-dicarboxylic acid, pyridazine-3,5-dicarboxylic acid, pyridazine-3,6-dicarboxylic acid, pyridazine-4,5-dicarboxylic acid, pyrimidine-2,4-dicarboxylic acid, pyrimidine-2,5-dicarboxylic acid, pyrimidine-4,5-dicarboxylic acid, pyrimidine-4,6-dicarboxylic acid, pyradine-2,3-dicarboxylic acid, pyradine-2,5-dicarboxylic acid, pyridine-2,6-dicarboxylic acid, triazine-2,4-dicarboxylic acid, 2-diethylamino-4,6-dimercapto-s-triazine, 2-dipropylamino-4,6-dimercapto-s-triazine, 2-dibutylamino-4,6-dimercapto-s-triazine, 2-anilino-4,6-dimercapto-s-triazine, 2,4,6-trimercapto-s-triazine, or other six-member heterocyclic compound which contains nitrogen atoms; may be mentioned.

Among these as well, from the viewpoint of further increasing the adhesion of the obtained resin film, the number of the acidic groups in the compound which has an acidic group is preferably two or more, particularly preferably three.

Further, among the compounds which have an acidic group or thermally latent acidic group, as specific examples of the compound which has a thermally latent acidic group, a compound which converts the acidic group of the compound which has an acidic group to a thermally latent acidic group may be mentioned. For example, it is possible to use 1,2,4-benzenetricarboxylic acid tris(1-propoxyethyl) which is obtained by converting the carboxy group of the 1,2,4-benzenetricarboxylic acid to a block carboxylic acid group as a compound which has a thermally latent acidic group. From the viewpoint of further increasing the adhesion of the obtained resin film, the number of the thermally latent acidic groups in the compound which has a thermolatent acidic group is preferably two or more, particularly preferably three.

The coupling agent or its derivative has the effect of better increasing the adhesion between a resin film comprised of a resin composition and the different layers which include a semiconductor layer which forms the semiconductor device board. As the coupling agent or its derivative, a compound which has one atom which is selected from a silicon atom, titanium atom, aluminum atom, or zirconium atom and has a hydrocarbyloxy group or hydroxy group which is bonded to that atom can be used.

As the coupling agent or its derivative, for example,

tetramethoxysilane, tetraethoxysilane, tetra-n-propoxysilane, tetra-i-propoxysilane, tetra-n-butoxysilane, or other tetraalkoxysilanes,

methyltrimethoxysilane, methyltriethoxysilane, ethyltrimethoxysilane, ethyltriethoxysilane, n-propyltrimethoxysilane, n-propyltriethoxysilane, i-propyltrimethoxysilane, propyltriethoxysilane, n-butyltrimethoxysilane, n-butyltriethoxysilane, n-pentyltrimethoxy-silane, n-hexyltrimethoxysilane, n-heptyltrimethoxysilane, n-octyltrimethoxysilane, n-decyltrimethoxysilane, p-styryltrimethoxysilane, vinyltrimethoxysilane, vinyltriethoxysilane, cyclohexyl trimethoxysilane, cyclohexyl trimethoxysilane, cyclohexyl triethoxysilane, phenyltrimethoxysilane, phenyltriethoxysilane, 3-chloropropyltrimethoxysilane, 3-chloropropyltriethoxysilane, 3,3,3-trifluoropropyltrimethoxysilane, 3,3,3-trifluoropropyltriethoxysilane, 3-aminopropyltrimethoxysilane, 3-aminopropyltriethoxysilane, N-2-(aminoethyl)-3-aminopropyltrimethoxysilane, N-phenyl-3-aminopropyltrimethoxysilane, 2-hydroxyethyltrimethoxysilane, 2-hydroxyethyltriethoxysilane, 2-hydroxypropyltrimethoxysilane, 2-hydroxypropyltriethoxysilane, 3-hydroxypropyltrimethoxysilane, 3-hydroxypropyltriethoxysilane, 3-mercaptopropyltrimethoxysilane, 3-mercaptopropyltriethoxysilane, 3-isocyanatepropyltrimethoxysilane, 3-isocyanatepropyltriethoxysilane, 3-glycidoxypropyltrimethoxysilane, 3-glycidoxypropyltriethoxysilane, 2-(3,4-epoxycyclohexyl)ethyltrimethoxysilane, 2-(3,4-epoxycyclohexyl)ethyl-triethoxysilane, 3-(meth)acryloxypropyltrimethoxysilane, 3-(meth)acryloxypropyltriethoxysilane, 3-ureidopropyltrimethoxysilane, 3-ureidopropyltriethoxysilane, 3-ethyl(trimethoxysilylpropoxymethyl) oxetane, 3-ethyl(triethoxysilylpropoxymethyl)oxetane, 3-triethoxysilyl-N-(1,3-dimethyl-butylidene)propylamine, bis(triethoxysilylpropyl)tetrasulfide, and other trialkoxysilanes,

dimethyldimethoxysilane, dimethyldiethoxysilane, diethyldimethoxysilane, diethyldiethoxysilane, di-n-propyldimethoxysilane, di-n-propyldiethoxysilane, di-i -propyldimethoxysilane, di-i-propyldiethoxysilane, di-n-butyldimethoxysilane, di-n-pentyldimethoxysilane, di-n-pentyldiethoxysilane, di-n-hexyldimethoxysilane, di-n-hexyldiethoxysilane, di-n-heptyldimethoxysilane, di-n-heptyldiethoxysilane, di-n-octyldimethoxysilane, di-n-octyldiethoxysilane, di-n-cyclohexyl dimethoxysilane, di-n-cyclohexyl diethoxysilane, diphenyldimethoxysilane, diphenyldiethoxysilane, 3-glycidoxypropylmethyldiethoxysilane, 3-methacryloxypropylmethyldimethoxysilane, 3-acryloxypropylmethyl dimethoxysilane, 3-methacryloxypropylmethyldiethoxysilane, 3-acryl oxypropylmethyldiethoxysilane, N-2-(aminoethyl)-3-aminopropylmethyl-dimethoxysilane, and other dialkoxysilanes

and also methyltriacetyloxysilane, dimethyldiacetyloxysilane, or other silicon atom-containing compounds;

tetra-i-propoxytitanium, tetra-n-butoxytitanium, tetrakis(2-ethylhexyl oxy)titanium, titanium-i-propoxyoctyleneglycolate, di-i -propoxy-bis(acetylacetonato)titanium, propanedioxytitanium bis(ethylacetoacetate), tri-n-butoxytitanium monostearate, di-i -propoxytitanium distearate, titanium stearate, di-i-propoxytitanium diisostearate, (2-n-butoxycarbonylbenzoyloxy)tributoxytitanium, di-n-butoxy-bis(triethanolaminato)titanium or also the Plain Act Series (made by Ajinomoto Fine-Techno)), or other titanium-atom containing compound;

acetoalkoxyaluminum diisopropylate, or other aluminum-atom containing compound;

tetranormal propoxyzirconium, tetranormal butoxyzirconium, zirconium tetraacetylacetonate, zirconium tributoxyacetylacetonate, zirconium monobutoxyacetylacetonate bis(ethylacetoacetate), zirconium dibutoxybis(ethylacetoacetate), zirconium tetraacetylacetonate, zirconium tributoxystearate, or other zirconium-atom containing compound; may be mentioned.

As specific examples of the sensitizer, 2H-pyrido-(3,2-b)-1,4-oxazin-3(4H)-ones, 10H-pyrido-(3,2-b)-1,4-benzothiazines, urazoles, hidantoins, barbituric acids, glycine anhydrides, 1-hydroxybenzotriazoles, alloxanes, maleimides, etc. may be mentioned.

As photostabilizers, benzophenone-based, salicyclic acid ester-based, benzotriazole-based, cyanoacrylate-based, metal complex salt-based, or other UV absorbents, hindered amine-based (HALS), and other ones which trap radicals produced by light, etc. may be used. Among these, HALS are compounds which have piperidine structures, have little coloring of the resin composition and are good in stability, so are preferable. As specific compounds, bis(2,2,6,6-tetramethyl-4-piperidyl)sebacate, 1,2,2,6,6-pentamethyl-4-piperidyl/tridecyl 1,2,3,4-butanetetracarboxylate, bis(1-octyloxy-2,2,6,6-tetramethyl-4-piperidyl)sebacate, etc. may be mentioned.

The method of preparation of the resin composition of the present invention is not particularly limited. The ingredients which form the resin composition may be mixed by a known method.

The method of mixing is not particularly limited, but mixing a solution or dispersion which is obtained by dissolving or dispersing the ingredients which form the resin composition in a solvent is preferable. Due to this, a resin composition is obtained in the form of a solution or dispersion.

The method of dissolving or dispersing the ingredients which form the resin composition in a solvent may be based on the ordinary method. Specifically, this may be performed by stirring using a stirring bar and magnetic stirrer, high speed homogenizer, disperser, planetary stirrer, twin-screw stirrer, ball mill, triple roll, etc. Further, the ingredients may also be dissolved or dispersed in a solvent, then for example filtered using a filter with a pore size of 0.5 μm or so etc.

The resin composition of the present invention usually has a solid content concentration of 1 to 70 wt %, preferably 5 to 60 wt %, more preferably 10 to 50 wt %. If the solid content concentration is in this range, the dissolution stability, coatability, uniformity of thickness of the resin film formed, flatness, etc. can be obtained with a high balance.

Further, the resin composition of the present invention contains the above-mentioned binder resin (A), radiation-sensitive compound (B), predetermined amount of silane-modified resin (C), and predetermined amount of antioxidant (D) as essential ingredients, and when coating the resin composition on a board etc. to form a thickness 2 to 3 μm resin film and baking the formed resin film at 230° C., an amount of warping of the obtained baked resin film is controlled in the range of 14 μm or less, preferably 13.5 μm or less, more preferably 13 μm or less. Further, the lower limit of the amount of warping is not particularly limited, but is usually 1 μm or more. By making it a thickness 2 to 3 μm resin film and controlling the amount of warping when baking at 230° C. to the above range, when using the resin composition of the present invention to make a resin film and when baking this, the obtained baked resin film can be made good in surface conditions and excellent in flatness, light resistance, and heat resistance. Note that, when forming a resin film which is used for measurement of the amount of warping, the thickness of the resin film is preferably 2.5 μm±0.1 μm. Further, the baking temperature may be outside the range if about ±1° C. from 230° C. Furthermore, the baking time is preferably 50 to 90 minutes, more preferably 60 minutes±5 minutes. Further, when measuring the amount of warping, it is possible to irradiate the resin film before baking by UV rays to cause a chemical reaction in the radiation-sensitive compound (B), then bake the film. Further, the resin composition of the present invention was controlled to give an amount of warping in the above-mentioned predetermined range when made into a thickness 2 to 3 μm resin film and baking it at 230° C., but when actually baking the resin composition of the present invention and using it as a baked resin film, the baking temperature is naturally not limited to 230° C. and can be suitably set in accordance with the applications etc. of the baked resin film to be obtained.

(Semiconductor Device Board)

Next, the semiconductor device board of the present invention will be explained. The semiconductor device board of the present invention has a resin film which is comprised of the above-mentioned resin composition of the present invention.

The semiconductor device board of the present invention may be configured by a board on which a semiconductor device is mounted. It is not particularly limited, but an active matrix board, organic EL device board, integrated circuit device board, solid state imaging device board, etc. may be mentioned. From the viewpoint of the particularly remarkable effect of improvement of the characteristics by formation of a resin film which is comprised of the above-mentioned resin composition of the present invention, an active matrix board and organic EL device board are preferable.

The active matrix board of one example of the semiconductor device board of the present invention is not particularly limited, but one where thin film transistors (TFTs) and other switching devices are arranged in a matrix on a board and the gate signal lines which supply a gate signal for driving the switching devices and source signal lines for supplying display signals to the switching device etc. are provided intersecting each other may be illustrated. Further, as a thin film transistor constiting one example of a switching device, a configuration comprised of a board on which a gate electrode, gate insulating layer, semiconductor layer, source electrode, and drain electrode may be illustrated.

Furthermore, as an organic EL device board constituted as one example of a semiconductor device board of the present invention, for example, one configured having a board on which light emitting parts each comprised of a cathode, hole injection and transport layer, organic light emitting layer constituted as a semiconductor layer, electron injection layer, anode, etc. and a picture element separating film for separating the light emitting parts may be illustrated.

Further, as the resin film which forms part of the semiconductor device board of the present invention, a resin film which is comprised of the above-mentioned resin composition and which is formed in contact with the surface of the semiconductor device which is mounted on the semiconductor device board or with the semiconductor layer which is included in the semiconductor device is preferable. While not particularly limited, when the semiconductor device board of the present invention is an active matrix board or organic EL device board, it can be configured as follows. That is, for example, when the semiconductor device board of the present invention is an active matrix board, the resin film comprised of the above-mentioned resin composition of the present invention can be made a protective film which is formed on the surface of the active matrix board or a gate insulating film which is formed in contact with the semiconductor layer of the thin film transistor which forms part of the semiactive matrix board (for example, amorphous silicon layer). Alternatively, when the semiconductor device board of the present invention is an organic EL device board, it may be made a sealing film which is formed on the surface of the organic EL device board or a picture element separating film for separating the light emitting parts which are contained in the organic EL device board (usually, each comprised of a cathode, hole injection and transport layer, organic light emitting layer constituted as a semiconductor layer, electron injection layer, anode, etc.).

In the semiconductor device board of the present invention, the method of forming the resin film is not particularly limited. For example, a coating method, film laminating method, or other method can be utilized.

The coating method is, for example, the method of coating the resin composition, then heating it to dry and remove the solvent. As the method of coating the resin composition, for example, the spray method, spin coat method, roll coat method, die coat method, doctor blade method, rotary coat method, bar coat method, screen printing method, or other various types of methods may be employed. The heating and drying conditions differ depending on the types and ratios of the ingredients, but usually is 30 to 150° C., preferably 60 to 120° C., usually for 0.5 to 90 minutes, preferably 1 to 60 minutes, more preferably 1 to 30 minutes.

The film laminating method is the method of coating the resin composition on a resin film or metal film or other B-stage film-forming base material, then heating and drying it to remove the solvent and obtain the B-stage film, then laminating this B-stage film. The heating and drying conditions can be suitably selected in accordance with the type of the ingredients and the ratio of formulation, but the heating temperature is usually 30 to 150° C. and the heating time is usually 0.5 to 90 minutes. The film lamination can be performed by using a pressure laminator, press, vacuum laminator, vacuum press, roll laminator, or other press bonder.

The thickness of the resin film is not particularly limited and may be suitably set in accordance with the application, but when the resin film is a protective film for active matrix board use or a sealing film for organic EL device board use, the thickness of the resin film is preferably 0.1 to 100 μm, more preferably 0.5 to 50 μm, furthermore preferably 0.5 to 30

Further, when the resin composition of the present invention includes a cross-linking agent (E), the resin film which is formed by the above coating method or film laminating method may be subjected to a cross-linking reaction. This cross-linking may be suitably selected in method in accordance with the type of the cross-linking agent (E), but is usually performed by heating. The heating method may, for example, be performed by using a hot plate, oven, etc. The heating temperature is usually 180 to 250° C., while the heating time is suitably selected in accordance with the area or thickness of the resin film, the equipment used, etc. For example, when using a hot plate, the treatment is usually performed for 5 to 60 minutes, while when using an oven, it is usually 30 to 90 minutes in range. The heating may in accordance with need be performed in an inert gas atmosphere. The inert gas may be one which does not contain oxygen and which does not cause the resin film to oxidize. For example, nitrogen, argon, helium, neon, xenon, krypton, etc. may be mentioned. Among these as well, nitrogen and argon are preferable. In particular, nitrogen is preferable. In particular, an inert gas with an oxygen content of 0.1 vol % or less, preferably 0.01 vol % or less, in particular nitrogen, is preferred. These inert gases may be used alone or in combinations of two or more types.

Further, when the resin film comprised of the above-mentioned resin composition is a protective film for an active matrix board, a sealing film for organic EL device board use, or other film formed with a predetermined pattern, it may be patterned. As the method for patterning the resin film, for example, the method may be mentioned of using the resin composition of the present invention to form the resin film before patterning, irradiating the resin film before patterning with active radiation to form a latent image pattern, then bringing a developing solution into contact with the latent image pattern so as to actualize the pattern.

The radiation is not particularly limited so long as able to activate the radiation-sensitive compound (B) which is contained in the resin composition and change the alkali solubility of the resin composition which contains the radiation-sensitive compound (B). Specifically, UV rays, g-rays or i-rays or other single wavelength UV rays, KrF excimer laser light, ArF excimer laser light, or other light beams; particle beams such as electron beams; etc. may be used. The method of irradiating such active radiation selectively in a pattern manner to form a latent image pattern may be based on an ordinary method. For example, a method of using a reduction projection exposure apparatus etc. to irradiate UV rays, g-rays, i-rays, KrF excimer laser light, ArF excimer laser light, or other light beams through a desired mask pattern, the method of using electron beams or other particle beams to draw patterns, etc. may be used. When using light beams as active radiation, single wavelength light or mixed wavelength light may be used. The irradiating conditions may be suitably selected in accordance with the active radiation which is used, but for example when using light of a wavelength of 200 to 450 nm, the amount of irradiation is usually 10 to 1,000 mJ/cm², preferably 50 to 500 mJ/cm² in range and is determined in accordance with the irradiation time and illuminance. After irradiating the active radiation in this way, in accordance with need, the resin film is heat treated at 60 to 130° C. or so in temperature for 1 to 2 minutes or so.

Next, the latent image pattern which was formed on the resin film before patterning is developed to actualize it. As the developing solution, usually an aqueous solution of an alkaline compound is used. As the alkaline compound, for example, an alkali metal salt, amine, or ammonium salt can be used. The alkaline compound may be an inorganic compound or may be an organic compound. As specific examples of these compounds, sodium hydroxide, potassium hydroxide, sodium carbonate, sodium silicate, sodium metasilicate, or other alkali metal salt; ammonia water; ethylamine, n-propylamine, or other primary amine; diethylamine, di-n-propylamine, or other secondary amine; triethylamine, methyldiethylamine, or other tertiary amine; tetramethylammonium hydroxide, tetraethylammonium hydroxide, tetrabutylammonium hydroxide, choline, or other quaternary ammonium salt; dimethylethanolamine, triethanolamine, or other alcoholamine; pyrrole, piperidine, 1,8-diazabicyclo[5.4.0]undec-7-ene, 1,5-diazabicyclo[4.3.0]non-5-ene, N-methylpyrrolidone, or other cyclic amine; etc. may be mentioned. These alkaline compounds may be used alone or in combination of two or more types.

As the aqueous medium of the alkali aqueous solution, water; methanol, ethanol, or other water soluble organic solvent may be used. The alkali aqueous solution may be one in which a suitable quantity of a surfactant etc. is added.

As the method for bringing a developing solution into contact with a resin film which has a latent image pattern, for example, the puddle method, spray method, dipping method, etc. may be used. The development is suitably selected from usually 0 to 100° C., preferably 5 to 55° C., more preferably 10 to 30° C. in range and usually for 30 to 180 seconds in range.

The resin film on which the target pattern is formed in this way can if necessary be rinsed by a rinse solution so as to remove the development residue. After the rinsing, the remaining rinse solution is removed by compressed air or compressed nitrogen.

Furthermore, in accordance with need, the radiation-sensitive compound (B) which is contained in the resin composition can be deactivated by irradiating the entire surface of the semiconductor device board with active radiation. For irradiating the active radiation, the method illustrated for formation of the above latent image pattern may be utilized. The resin film may be heated at the same time as be irradiated or after irradiated. As the heating method, for example, the method of heating the semiconductor device board by a hot plate or in an oven may be mentioned. The temperature is usually 100 to 300° C., preferably 120 to 200° C. in range.

In the present invention, the resin film can be subjected to a cross-linking reaction after patterning. The cross-linking may be performed in accordance with the above-mentioned method.

The resin composition of the present invention contains the above-mentioned binder resin (A), radiation-sensitive compound (B), a predetermined amount of silane-modified resin (C), and a predetermined amount of antioxidant (D) as essential ingredients, and when coating the resin composition on a board etc. to form a thickness 2 to 3 μm resin film and baking the formed resin film at 230° C., an amount of warping of the obtained baked resin film is controlled in the range of 14 μm or less. Therefore, the resin film which is obtained using the resin composition of the present invention is reduced in warping due to baking even after baking and further is good in surface conditions and excellent in flatness, light resistance, and heat resistance. Further, according to the present invention, by applying the resin film which is obtained by using the resin composition of the present invention to a semiconductor device board, it becomes possible to uniformly form an inorganic film etc. on the resin film which is obtained by using the resin composition of the present invention. Due to this, higher performance of the semiconductor device board becomes possible.

### EXAMPLES

Below, examples and comparative examples will be given to explain the present invention in more detail. In the examples, the “parts” are based on weight unless particularly indicated otherwise.

Note that, the definitions of the different properties and the methods of evaluation are as follows.

<Polymerization Conversion Rate>

After the end of the polymerization reaction, gas chromatography was used to measure the residual amount of monomer in the reaction solution. The rate was calculated from this value.

<Hydrogenation Rate>

The ¹H-NMR spectrum was used to find the number of moles of hydrogenated carbon-carbon double bonds as the ratio to the number of moles of carbon-carbon double bonds before hydrogenation. The ratio of hydrogenated carbon-carbon double bonds based on the state before hydrogenation was found as mol %.

<Weight Average Molecular Weight−Number Average Molecular Weight>

Gel permeation chromatography (abbreviation GPC, made by Tosoh, Model No. “HLC-8020”, three types of columns of TSKgel SuperH2000, TSKgel SuperH4000, and TSKgel SuperH5000 combined for use) was used to calculate the molecular weight converted to polystyrene. Note that, as the development solvent, tetrahydrofuran was used.

<Amount of Warping of Resin Film>

A 4-inch silicon wafer was spin coated with a resin composition, then a hot plate was used to prebake it at 100° C. for 2 minutes to form a thickness 2.5 μm resin film. Next, this resin film was treated by dipping it in a 0.4 wt % tetramethylammonium hydroxide aqueous solution at 23° C. for 120 seconds, then was washed by ultrapure water for 30 seconds, then was irradiated by UV light with a light intensity at 365 nm of 5 mW/cm² for 100 seconds in the air. Further, the resin film which was irradiated by UV light was post-baked using an oven for heating at 230° C. for 60 minutes to thereby obtain a test sample comprised of a silicon wafer on which a resin film was formed. Further, the obtained test sample was measured for the amount of warping of the resin film by using a “Flatness Tester FT-17” (made by Nidek). This was evaluated by the following criteria.

Good: Amount of warping of resin film of 14 μm or less.

Poor: Amount of warping of resin film larger than 14 μm.

<Surface Conditions of Resin Film>

A resin film which was obtained in the same way as the above evaluation of warping was examined for surface conditions of the resin film using an optical microscope. This was evaluated by the following criteria.

Good: No white turbidity, cracks, or wrinkles were observed.

Fair: White turbidity was observed.

Poor: Cracks and wrinkles were observed.

<Flatness>

A resin film which was obtained in the same way as the above evaluation of warping was measured for flatness of the resin film using an atomic force microscope (AlN. This was evaluated by the following criteria.

Good: Surface roughness Ra of less than 3 nm.

Poor: Surface roughness Ra of 3 nm or more.

<Light Resistance>

A glass board (made by Corning, Eagle XG 100 mm square) was spin coated by a resin composition, then prebaked using a hot plate at 100° C. for 2 minutes to form a thickness 2 μm resin film. Next, this resin film was treated by being dipped in a 0.4 wt % tetramethylammonium hydroxide aqueous solution at 23° C. for 120 seconds, then was washed with ultrapure water for 30 seconds. Next, UV light with a light intensity at 365 nm of 5 mW/cm² was irradiated for 100 seconds in the air. Further, the resin film which was irradiated by UV rays was post-baked by heating using an oven at 230° C. for 60 minutes so as to obtain test use samples comprised of glass boards on which resin film was formed. Further, the obtained test samples were irradiated by visible light with 390 nm and less cut using a light resistance tester (Suga Metering Illuminating Tester, Suga Test Instruments) and UV filter (L-39, made by Asahi Technoglass) by an illuminance of 125,000 lux under conditions of a temperature of 25° C. and a humidity of 40% RH for 50 hours. The change in color of the test samples was evaluated visually. Further, the samples which were not irradiated by light and the test samples which were irradiated by light were compared and evaluated based on the following criteria.

Good: No change seen in color of test sample which were irradiated by light.

Poor: Yellowing of test sample which was irradiated by light.

<Heat Resistance>

A silicon nitride film board (board on which silicon nitride film of thickness of 200 nm is formed on a silicon board by chemical vapor deposition (CVD)) was coated by a resin composition by the spin coating method. A hot plate was used to heat and dry the film by 90° C. for 2 minutes (prebaked) to form a thickness 2.5 μm resin film. Next, to perform patterning of the resin film, exposure was performed using a mask which can form various contact hole patterns differing in size from 0.5 μm to 5.0 μm every 0.5 μm and various contact hole patterns of 10 μm, 25 μm, and 50 μm. Next, a 2.38 wt % tetramethylammonium hydroxide aqueous solution was used for development at 23° C. for 40 seconds, then ultrapure water was used for rinsing for 30 seconds to obtain a laminate which is comprised of a resin film on which a pattern of contact holes different in size is formed and a silicon nitride film board.

Further, an optical microscope was used to measure the length (L1) of the longest part of a 5 μm square contact hole pattern of the resin film of the obtained laminate. Next, the laminate was heated using an oven in a nitrogen atmosphere at 230° C. for 30 minutes. Further, an optical microscope was used to examine the heated laminate, the length (L2) of the longest parts of the contact hole patterns which were observed before heating was measured, and the pattern retention rate after heating was calculated in accordance with (L2/L1)×100 (units are %) so as to evaluate the heat resistance of the resin film. The closer the pattern retention rate after heating to 100%, the smaller the change in the contact hole patterns after the heating step and the better the heat resistance that can be judged. Note that, the evaluation was performed based on the following criteria.

Good: Pattern retention rate within range of 100%±20%.

Poor: Pattern retention rate outside range of 100%±20%.

### Synthesis Example 1

### Preparation of Cyclic Olefin Polymer (A-1)

A monomer mixer comprised of 40 mol % of N-(2-ethylhexyl)-bicyclo[2.2.1]hept-5-ene-2,3-dicarboxylmide and 60 mol % of 4-hydroxycarbonyltetracyclo[6.2.1.1^{3,6}.0^{2,7}]dodec-9-ene 100 parts, 1,5-hexadiene 2 parts, (1,3-dimesitylimidazolin-2-ylidene)(tricyclohexyl phosphine)benzylideneruthenium dichloride (synthesized by method described in Org. Lett., Vol. 1, page 953, 1999) 0.02 part, and diethyleneglycol ethylmethylether 200 parts were charged into a glass pressure resistant reactor in which the inside is replaced by nitrogen. The mixture was stirred while causing a reaction at 80° C. for 4 hours to obtain a polymerization reaction solution.

Further, the obtained polymerization reaction solution is placed in an autoclave and stirred at 150° C. at a hydrogen pressure of 4 MPa for 5 hours to perform a hydrogenation reaction to obtain a polymer (A-1) solution which contains a cyclic olefin polymer. The polymerization conversion rate of the obtained polymer was 99.7 wt %, the weight average molecular weight converted to polystyrene was 7,150, the number average molecular weight was 4,690, the molecular weight distribution was 1.52, and the hydrogenation rate was 99.7%. Further, the obtained cyclic olefin polymer solution had a solid content concentration of 34.4 wt %.

### Synthesis Example 2

### Preparation of Acrylic Polymer (A-2)

A flask which was equipped with a cooling tube and an agitator was charged with 2,2′-azobis-(2,4-dimethylvaleronitrile) 7 parts and diethyleneglycol ethylmethylether 200 parts. After this, methacrylic acid 16 parts, tricyclo[5.2.1.0^{2,6}]decan-8-yl methacrylate 16 parts, 2-methylcyclohexyl acrylate 20 parts, glycidyl methacrylate 40 parts, styrene 10 parts, and α-methylstyrene dimer 3 parts were charged and the inside was replaced with nitrogen and then the mixture slowly started to be stirred. Next, the solution was raised in temperature to 70° C. This temperature was held for 4 hours to obtain a polymer solution which contains an acrylic polymer (A-2). The acrylic polymer (A-2) had a weight average molecular weight (Mw) converted to polystyrene of 8,000 and a molecular weight distribution (Mw/Mn) of 2.3. Further, the obtained acrylic polymer (A-2) solution had a solid content concentration of 34.4 wt %.

### Synthesis Example 3

### Preparation of Photosensitive Polyimide Precursor (A-3)

A reactor was charged with 2,2′-di(p-aminophenyl)-6,6′-bisbenzoxazole 28.11 g (0.0672 mol) and a solvent 200 g (dimethylacetoamide (DMAc) 100 g and N-methyl-2-pyrrolidone (NMP)100 g) to prepare a mixed solution. To this solution, pyromellitic acid dianhydride 15.26 g (0.07 mol) was added as a powder while ice cooling and stirring and a solvent 20 g (DMAc 10 g and NMP 10 g) was added for washing.

Next, the solution was stirred under ice cooling while stirring for 2 hours, then the reaction temperature was raised to 30° C. and a reaction was caused for 2 hours. When the reaction solution became substantially uniform, the reaction solution was cooled to 10° C., then p-aminobenzoic acid[tris(methacryloyl)pentaerythritol]ester 2.57 g (0.0056 mole) was added and a solvent 20 g (DMAc 10 g and NMP 10 g) was added for washing. The solution was reacted at 10° C. for 2 hours then at 25° C. for 12 hours to synthesize a photosensitive polyimide precursor (polyamic acid)(A-3) by a resin concentration of 16 wt %. This photosensitive polyimide precursor had a terminal modification rate of 8%.

### Synthesis Example 4

### Preparation of Poly(methyltrimethoxysilane)

A flask which was provided with a stirrer, reflux cooling tube, and thermometer was charged with methyltrimethoxysilane 136 parts and methanol 32 parts. Next, these were stirred at ordinary temperature while adding dropwise over 5 minutes an aqueous solution of ion exchanged water 13.5 parts (0.75 molar equivalent with respect to methyltrimethoxysilane) into which concentrated hydrochloric acid 0.1 part was dissolved and the reaction continued for 4 hours. Further, after reaction for 4 hours, the reflux cooling tube was replaced with a distillation tube, then the low boiling point ingredients were distilled off at a temperature of 80° C. at ordinary pressure for 30 minutes, then were distilled off at a temperature of 100° C. until a pressure of 0.3 KPa so as to obtain poly(methyltrimethoxysilane). The obtained poly(methyltrimethoxysilane) was analyzed by gel permeation chromatography (GPC), whereupon the obtained poly(methyltrimethoxysilane) was an oligomer with a weight average molecular weight of 490 (converted to polystyrene) and contents of the unreacted silane compound and low condensate of 7% or less (GPC area percentage).

### Synthesis Example 5

### Preparation of Silane-Modified Epoxy Resin (C-1) Solution

A reaction apparatus which was provided with a stirrer, cooling tube, and thermometer was charged with bisphenol A type epoxy resin (epoxy equivalents 480 g/eq) 800.0 parts and diethyleneglycol dimethylether 960.0 parts which were then dissolved at 80° C. Further, to this, the poly(methyltrimethoxysilane) which was obtained in Synthesis Example 4, 605.0 parts and a catalyst constituted by dibutyltin laurate 2.3 parts were added and the mixture reacted at 80° C. for 5 hours to perform methanol elimination reaction and obtain the silane-modified epoxy resin (C-1) solution. Note that, the obtained silane-modified epoxy resin had an effective ingredient (after curing) of 50 wt % and a weight converted to silica/weight of bisphenol type epoxy resin (weight ratio) of 0.51 and epoxy equivalent of 1400 g/eq. Further, the fact that 87 mol % of the methoxy groups of the partial condensate ingredient of the poly(methyltrimethoxysilane) was maintained was confirmed by ¹H-NMR.

### Synthesis Example 6

### Preparation of Silane-Modified Phenol Resin (C-2)

A reaction apparatus which was provided with a stirrer, water separator, thermometer, and nitrogen gas introduction tube was charged with a novolac type phenol resin (made by Arakawa Chemical Industries, product name Tamanol 759) 800 parts and the poly(methyltrimethoxysilane) which was obtained at Synthesis Example 4, 590.3 parts which were then melted and mixed at 100° C. To this, a catalyst constituted by dibutyltin dilaurate 3 parts was added and the mixture reacted at 110° C. for 7 hours to perform methanol elimination reaction. Due to this, 80 parts of methanol were distilled off to obtain a silane-modified phenol resin (C-2).

### Synthesis Example 7

### Production of Epoxy-Group Containing Methoxysilane Partial Condensate

A reaction apparatus which was provided with a stirrer, water separator, thermometer, and nitrogen gas introduction tube was charged with glycidol 1400 parts and the poly(methyltrimethoxysilane) which was obtained in Synthesis Example 4, 9140 parts. These were stirred in a nitrogen stream while raising the temperature to 90° C., then dibutyltin laurate 2.2 parts were added to cause a reaction. During the reaction, a water separator was used to distill off the produced methanol and this was cooled when the amount reached about 630 parts. The time required until the cooling after raising the temperature was 6 hours. Next, about 30 parts of methanol which remained in the system were removed in vacuo at 13 kPa for about 10 minutes to obtain a partial condensate of an epoxy-group containing alkoxysilane.

### Synthesis Example 8

### Preparation of Silane-Modified Polyamic Acid (C-3)

A 2-liter three-necked flask which was provided with a stirrer, cooling tube, thermometer, and nitrogen gas introduction tube was charged with 4,4′-diaminodiphenylether 112 parts and N-methylpyrrolidone 1170 parts. These were mixed well at room temperature, then cooled to 60° C. or less while adding pyromellitic dianhydride 118 parts and stirring for 30 minutes to synthesize polyamic acid. The solid residue converted to polyimide of the obtained polyamic acid was 15 wt %. Next, N-methylpyrrolidone 500 parts was added and the mixture was raised to 80° C. The partial condensate of the epoxy-group containing alkoxysilane which was obtained in Synthesis Example 7, 40.2 parts and the catalyst constituted by 2-methylimidazole 0.24 part were added and reacted at 80° C. for 4 hours. Further, after reaction for 4 hours, the mixture was cooled to room temperature to obtain a curing residue 12 wt % silane-modified polyamic acid (C-3).

### Synthesis Example 9

### Production of Glycidylether-Group Containing Tetramethoxysilane Partial Condensate

A reaction apparatus which was provided with a stirrer, water separator, thermometer, and nitrogen gas introduction tube was charged with glycidol 1,400 parts and tetramethoxysilane partial condensate (made by Tama Chemicals, product name “Methyl Silicate 51”, average number of Si atoms in one molecule: 4, number average molecular weight: 480) 8,957.9 parts. The mixture was raised in temperature to 90° C. in a nitrogen stream while stirring then adding a catalyst constituted by dibutyltin laurate 2.0 parts so as to make these react. During the reaction, a water separator was used to distill off the produced methanol. This was cooled when the amount reached about 550 parts. The time required until the cooling after raising the temperature was 5 hours. Next, about 68 parts of methanol which remained in the system were removed in vacuo at 13 kPa for about 10 minutes to obtain a partial condensate of a glycidylether-group containing tetramethoxysilane.

### Synthesis Example 10

### Preparation of Silane-Modified Acrylic resin (C-4)

A reaction apparatus which was provided with a stirrer, cooling tube, thermometer, and gas introduction tube was charged with diethyleneglycol dimethylether 1461 parts. This was raised in temperature under a nitrogen stream to 100° C., then a mixed monomer comprised of butyl methacrylate 417 parts and hydroxyethyl acrylate 83.3 parts and ditertiary butylperoxide 25 parts were added dropwise over 1 hour. Furthermore, a mixed monomer comprised of methyl methacrylate 250 parts and methacrylic acid 83.3 parts and ditertiary butyl peroxide 10 parts were added dropwise over 1 hour. The mixture was allowed to further react at 120° C. for 3 hours to obtain a solid content 37 wt % carboxyl-group containing acrylic polymer solution. The obtained carboxyl-group containing acrylic polymer had a number average molecular weight of 50,000 and an acid value (per solid content) of 65 mgKOH/g.

Further, the carboxyl-group containing acrylic polymer solution prepared by the above method 700 parts, a partial condensate of the glycidylether-group containing tetramethoxysilane which was obtained by the Synthesis Example 9, 152 parts and methanol 30 parts were charged into a similar reaction apparatus and made to react under a nitrogen stream at 80° C. for 6 hours to obtain a curing residue 38.3 wt % silane-modified acrylic resin (C-4).

### Example 1

### Preparation of Resin Composition

A binder resin (A) constituted by the cyclic olefin polymer (A-1) solution which was obtained in Synthesis Example 1, 291 parts (cyclic olefin polymer (A-1) 100 parts), a solvent constituted by diethyleneglycol ethylmethylether 359 parts, a radiation-sensitive compound (B) constituted by a condensate of 1,1,3-tris(2,5-dimethyl-4-hydroxyphenyl)-3-phenyl propane (1 mole) and 1,2-naphthoquinonediazide-5-sulfonic acid chloride (2 moles) (B-1) 30 parts, a silane-modified resin (C) constituted by the silane-modified epoxy resin (C-1) solution which was obtained in Synthesis Example 5, 20 parts (silane-modified epoxy resin (C-1) 10 parts), an antioxidant (D) constituted by pentaerythritol tetrakis[3-(3′,5′-di-tert-butyl-4′-hydroxyphenyl)propionate] (D-1) 2 parts, and a cross-linking agent (E) constituted by 3,4-epoxycyclohexenylmethyl-3′,4′-epoxycyclohexenecarboxylate (E-1) 30 parts, and a surfactant constituted by 1,2,4-benzenetricarboxylic acid 3 parts were mixed and dissolved, then the mixture was filtered by a pore size 0.45 μm polytetrafluoroethylene filter to prepare a resin composition.

Then, the above obtained resin composition was used to evaluate the amount of warping of the resin film and the surface conditions of the resin film, flatness, light resistance, and heat resistance. The results are shown in Table 1.

### Example 2

Except for changing the amount of the radiation-sensitive compound (B) constituted by the condensate of 1,1,3-tris(2,5-dimethyl-4-hydroxyphenyl)-3-phenyl propane (1 mole) and 1,2-naphthoquinonediazide-5-sulfonic acid chloride (2 moles) from 30 parts to 40 parts, the same procedure was followed as in Example 1 to obtain a resin composition and similarly evaluate it. The results are shown in Table 1.

### Example 3

Except for using as the radiation-sensitive compound (B), instead of the condensate of 1,1,3-tris(2,5-dimethyl-4-hydroxyphenyl)-3-phenyl propane (1 mole) and 1,2-naphthoquinonediazide-5-sulfonic acid chloride (2 moles)(B-1), a condensate of 4,4′-[1-[4-[1-(4-hydroxyphenyl)-1-methylethyl]phenyl]ethylidene]bisphenol (1 mole) and 1,2-naphthoquinonediazide-5-sulfonic acid chloride (2 moles)(B-2) 30 parts, the same procedure was followed as in Example 1 to obtain a resin composition and similarly evaluate it. The results are shown in Table 1.

### Example 4

Except for using as the radiation-sensitive compound (B), instead of the condensate of 1,1,3-tris(2,5-dimethyl-4-hydroxyphenyl)-3-phenyl propane (1 mole) and 1,2-naphthoquinonediazide-5-sulfonic acid chloride (2 moles)(B-1), a condensate of 2,3,4,4′-tetrahydroxybenzophenone (1 mol) and 1,2-naphthoquinonediazide-5-sulfonic acid chloride (2 moles) (B-3) 30 parts, the same procedure was followed as in Example 1 to obtain a resin composition and similarly evaluate it. The results are shown in Table 1.

### Example 5

Except for changing the amount of the silane-modified resin (C) constituted by a silane-modified epoxy resin (C-1) from 10 parts to 50 parts, the same procedure was followed as in Example 1 to obtain a resin composition and similarly evaluate it. The results are shown in Table 1.

### Example 6

Except for changing the amount of the silane-modified resin (C) constituted by a silane-modified epoxy resin (C-1) from 10 parts to 1 part, the same procedure was followed as in Example 1 to obtain a resin composition and similarly evaluate it. The results are shown in Table 1.

### Example 7

Except for using as the silane-modified resin (C), instead of the silane-modified epoxy resin (C-1), the silane-modified phenol resin (C-2) which was obtained at Synthesis Example 6, 10 parts, the same procedure was followed as in Example 1 to obtain a resin composition and similarly evaluate it. The results are shown in Table 1.

### Example 8

Except for using as the silane-modified resin (C), instead of the silane-modified epoxy resin (C-1), the silane-modified polyamic acid (C-3) which was obtained at Synthesis Example 8, 10 parts, the same procedure was followed as in Example 1 to obtain a resin composition and similarly evaluate it. The results are shown in Table 1.

### Example 9

Except for using as the silane-modified resin (C), instead of the silane-modified epoxy resin (C-1), the silane-modified acrylic acid (C-4) which was obtained in Synthesis Example 10, 10 parts, the same procedure was followed as in Example 1 to obtain a resin composition and similarly evaluate it. The results are shown in Table 1.

### Example 10

Except for changing the amount of the antioxidant (D) constituted by pentaerythritol tetrakis[3-(3′,5′-di-tert-butyl-4′-hydroxyphenyl) propionate] (D-1) from 2 parts to 7 parts, the same procedure was followed as in Example 1 to obtain a resin composition and similarly evaluate it. The results are shown in Table 1.

### Example 11

Except for using as the antioxidant (D), instead of the pentaerythritol tetrakis[3-(3′,5′-di-tert-butyl-4′-hydroxyphenyl)propionate] (D-1), 6-(4-hydroxy-3,5-di-t-butylanilino)-2,4-bis-octylthio-1,3,5-triazine (D-2) 2 parts, the same procedure was followed as in Example 1 to obtain a resin composition and similarly evaluate it. The results are shown in Table 1.

### Example 12

Except for using as the antioxidant, instead of the pentaerythritol tetrakis[3-(3′,5′-di-tert-butyl-4′-hydroxyphenyl)propionate] (D-1), tris(nonylphenyl)phosphite (D-3) 2 parts, the same procedure was followed as in Example 1 to obtain a resin composition and similarly evaluate it. The results are shown in Table 1.

### Example 13

Except for changing the amount of the cross-linking agent constituted by 3,4-epoxycyclohexenylmethyl-3′,4′-epoxycyclohexenecarboxylate (E-1) from 30 parts to 60 parts, the same procedure was followed as in Example 1 to obtain a resin composition and similarly evaluate it. The results are shown in Table 1.

### Example 14

Except for using as the cross-linking agent, instead of 3,4-epoxycyclohexenylmethyl-3′,4′-epoxycyclohexenecarboxylate (E-1), a 1,2-epoxy-4-(2-oxiranyl)cyclohexane adduct of 2,2-bis(hydroxymethyl)-1-butanol (E-2) 30 parts, the same procedure was followed as in Example 1 to obtain a resin composition and similarly evaluate it. The results are shown in Table 2.

### Example 15

Except for using as the binder resin (A), instead of the cyclic olefin polymer (A-1) solution, the acrylic polymer (A-2) solution which was obtained in Synthesis Example 2, 291 parts (acrylic polymer (A-2) 100 parts), the same procedure was followed as in Example 1 to obtain a resin composition and similarly evaluate it. The results are shown in Table 2.

### Example 16

Except for using as the radiation-sensitive compound (B), instead of the condensate of 1,1,3-tris(2,5-dimethyl-4-hydroxyphenyl)-3-phenyl propane (1 mole) and 1,2-naphthoquinonediazide-5-sulfonic acid chloride (2 moles)(B-1), a condensate of 4,4′-[1-[4-[1-(4-hydroxyphenyl)-1-methylethyl]phenyl]ethylidene]bisphenol (1 mole) and 1,2-naphthoquinonediazide-5-sulfonic acid chloride (2 moles)(B-2) 30 parts, the same procedure was followed as in Example 15 to obtain a resin composition and similarly evaluate it. The results are shown in Table 2.

### Example 17

Except for using as the silane-modified resin (C), instead of the silane-modified epoxy resin (C-1), the silane-modified phenol resin (C-2) which was obtained in Synthesis Example 6, 10 parts, the same procedure was followed as in Example 15 to obtain a resin composition and similarly evaluate it. The results are shown in Table 2.

### Example 18

Except for using as the antioxidant (D), instead of the pentaerythritol tetrakis[3-(3′,5′-di-tert-butyl-4′-hydroxyphenyl)propionate] (D-1), 6-(4-hydroxy-3,5-di-t-butylanilino)-2,4-bis-octylthio-1,3,5-triazine (D-2) 2 parts, the same procedure was followed as in Example 15 to obtain a resin composition and similarly evaluate it. The results are shown in Table 2.

### Example 19

A binder resin (A) constituted by the photosensitive polyimide precursor (A-3) solution which was obtained in Synthesis Example 3, 625 parts (polyimide precursor (A-3) 100 parts), a solvent constituted by diethyleneglycol ethylmethylether 359 parts, a radiation-sensitive compound (B) constituted by triethyleneglycol diacrylate (B-4) 28 parts, N-phenylglycine (B-5) 2 parts, and 3,3′,4,4′-tetra(t-butylperoxycarbonyl)benzophenone (B-6) 2 parts, a silane-modified resin (C) constituted by the silane-modified epoxy resin (C-1) solution which was obtained in Synthesis Example 5, 20 parts (silane-modified epoxy resin (C-1) 10 parts), an antioxidant (D) constituted by pentaerythritol tetrakis[3-(3′,5′-di-tert-butyl-4′-hydroxyphenyl)propionate] (D-1) 2 parts, and a cross-linking agent (E) constituted by 3,4-epoxycyclohexenylmethyl-3′,4′-epoxycyclohexenecarboxylate (E-1) 30 parts, and a surfactant constituted by 1,2,4-benzenetricarboxylic acid 3 parts were mixed and made to dissolve, then the mixture was filtered by a pore size 0.45 μm polytetrafluoroethylene filter to prepare a resin composition. Further, the obtained resin composition was evaluated in the same way as Example 1. The results are shown in Table 2.

### Comparative Example 1

Except for changing the amount of the silane-modified resin (C) constituted by the silane-modified epoxy resin (C-1) solution from 10 parts to 0.05 part, the same procedure was followed as in Example 1 to obtain a resin composition and similarly evaluate it. The results are shown in Table 2.

### Comparative Example 2

Except for changing the amount of the silane-modified resin (C) constituted by the silane-modified epoxy resin (C-1) solution from 10 parts to 200 parts, the same procedure was followed as in Example 1 to obtain a resin composition and similarly evaluate it. The results are shown in Table 2.

### Comparative Example 3

Except for changing the amount of the antioxidant (D) constituted by pentaerythritol tetrakis[3-(3′,5′-di-tert-butyl-4′-hydroxyphenyl) propionate] (D-1) from 2 parts to 0.05 part, the same procedure was followed as in Example 1 to obtain a resin composition and similarly evaluate it. The results are shown in Table 2.

### Comparative Example 4

Except for changing the amount of the antioxidant (D) constituted by pentaerythritol tetrakis[3-(3′,5′-di-tert-butyl-4′-hydroxyphenyl) propionate] (D-1) from 2 parts to 15 parts, the same procedure was followed as in Example 1 to obtain a resin composition and similarly evaluate it. The results are shown in Table 2.

### Comparative Example 5

Except for changing the amount of the radiation-sensitive compound (B) constituted by a condensate of 1,1,3-tris(2,5-dimethyl-4-hydroxyphenyl)-3-phenylpropane (1 mole) and 1,2-naphthoquinonediazide-5-sulfonic acid chloride (2 moles)(B-1) from 30 parts to 5 parts and changing the amount of the silane-modified resin (C) constituted by a silane-modified epoxy resin (C-1) solution from 10 parts to 1 part, the same procedure was followed as in Example 15 to obtain a resin composition and similarly evaluate it. The results are shown in Table 2.

### Comparative Example 6

Except for changing the amount of the antioxidant (D) constituted by pentaerythritol tetrakis[3-(3′,5′-di-tert-butyl-4′-hydroxyphenyl) propionate] (D-1) from 2 parts to 15 parts, the same procedure was followed as in Example 19 to obtain a resin composition and similarly evaluate it. The results are shown in Table 2.

TABLE 1

| Examples | | | | | | | | | | | | |
|---|---|---|---|---|---|---|---|---|---|---|---|---|
| 1 | 2 | 3 | 4 | 5 | 6 | 7 | 8 | 9 | 10 | 11 | 12 | 13 |

Composition of resin composition

| | | | | | | | | | | | | | | |
|---|---|---|---|---|---|---|---|---|---|---|---|---|---|---|
| Cyclic olefin polymer (A-1) | (parts) | 100 | 100 | 100 | 100 | 100 | 100 | 100 | 100 | 100 | 100 | 100 | 100 | 100 |
| Acrylic polymer (A-2) | (parts) | | | | | | | | | | | | | |
| Photosensitive polyimide | | | | | | | | | | | | | | |
| precursor (A-3) | | | | | | | | | | | | | | |
| Condensate of 1,1,3-tris(2,5- | (parts) | 30 | 40 | 30 | 30 | 30 | 30 | 30 | 30 | 30 | 30 | 30 | | |
| dimethyl-4-hydroxyphenyl)-3- | | | | | | | | | | | | | | |
| phenylpropane (1 mole) and 1,2- | | | | | | | | | | | | | | |
| naphthoquinoneazido-5-sulfonic | | | | | | | | | | | | | | |
| acid chloride (2 moles) (B-1) | | | | | | | | | | | | | | |
| Condensate of 4,4′-[1-[4-[1-(4- | (parts) | | | 30 | | | | | | | | | | |
| hydroxyphenyl)-1-methylethyl] | | | | | | | | | | | | | | |
| phenyl]ethylidene]bisphenol | | | | | | | | | | | | | | |
| and 1,2-naphthoquinone diazide-5- | | | | | | | | | | | | | | |
| sulfonic acid chloride (B-2) | | | | | | | | | | | | | | |
| Condensate of 2,3,4,4′- | (parts) | | | | 30 | | | | | | | | | |
| tetrahydroxybenzophenone | | | | | | | | | | | | | | |
| and 1,2-naphthoquinoneazido- | | | | | | | | | | | | | | |
| 5-sulfonic acid chloride (B-3) | | | | | | | | | | | | | | |
| Triethyleneglycol diacrylate (B-4) | (parts) | | | | | | | | | | | | | |
| N-phenylglycidine (B-5) | (parts) | | | | | | | | | | | | | |
| 3,3′,4,4′-tetra(t-butylperoxycarbonyl) | (parts) | | | | | | | | | | | | | |
| benzophenone (B-6) | | | | | | | | | | | | | | |
| Silane-modified epoxy resin (C-1) | (parts) | 10 | 10 | 10 | 10 | 50 | 1 | | | | 10 | 10 | 10 | 10 |
| Silane-modified phyenol resin (C-2) | (parts) | | | | | | | 10 | | | | | | |
| Silane-modified polyamic acid (C-3) | (parts) | | | | | | | | 10 | | | | | |
| Silane-modified acrylic resin (C-4) | (parts) | | | | | | | | | 10 | | | | |
| Pentaerythritol tetrakis | (parts) | 2 | 2 | 2 | 2 | 2 | 2 | 2 | 2 | 2 | 7 | | | 2 |
| [3-(3′,5′-di-tert-butyl-4′- | | | | | | | | | | | | | | |
| hydroxyphenyl)propionatel] (D-1) | | | | | | | | | | | | | | |
| 6-(4-hydroxy-3,5-di-t-butylanilino)-2, | (parts) | | | | | | | | | | | 2 | | |
| 4-bis-ocryithio-1,3,5-triazine (D-2) | | | | | | | | | | | | | | |
| Tris(nonylphenyl)phosphite (D-3) | (parts) | | | | | | | | | | | | 2 | |
| 3,4-epoxycyclohexenylmethyl-3′,4′- | (parts) | 30 | 30 | 30 | 30 | 30 | 30 | 30 | 30 | 30 | 30 | 30 | 30 | 60 |
| epoxycyclohexenecarboxylate (E-1) | | | | | | | | | | | | | | |
| 1,2-epoxy-4-(2-oxiranyl)cyclohexane | (parts) | | | | | | | | | | | | | |
| adduct of 2,2-bis(hydroxymethyl)- | | | | | | | | | | | | | | |
| 1-butanol (E-2) | | | | | | | | | | | | | | |
| 1,2,4-benzenetricarboxylic acid | (parts) | 3 | 3 | 3 | 3 | 3 | 3 | 3 | 3 | 3 | 3 | 3 | 3 | 3 |

Evaluation

| | | | | | | | | | | | | | |
|---|---|---|---|---|---|---|---|---|---|---|---|---|---|
| Amount of warping of resin film | Good | Good | Good | Good | Good | Good | Good | Good | Good | Good | Good | Good | Good |
| Surface conditions of resin film | Good | Good | Good | Good | Good | Good | Good | Good | Good | Good | Good | Good | Good |
| Flatness | Good | Good | Good | Good | Good | Good | Good | Good | Good | Good | Good | Good | Good |
| Light resistance | Good | Good | Good | Good | Good | Good | Good | Good | Good | Good | Good | Good | Good |
| Heat resistance | Good | Good | Good | Good | Good | Good | Good | Good | Good | Good | Good | Good | Good |

TABLE 2

| Examples | | | | | | Comparative Examples | | | | | |
|---|---|---|---|---|---|---|---|---|---|---|---|
| 14 | 15 | 16 | 17 | 18 | 19 | 1 | 2 | 3 | 4 | 5 | 6 |

Composition of resin composition

| | | | | | | | | | | | | | |
|---|---|---|---|---|---|---|---|---|---|---|---|---|---|
| Cyclic olefin polymer (A-1) | (parts) | 100 | | | | | | 100 | 100 | 100 | 100 | | |
| Acrylic polymer (A-2) | (parts) | | 100 | 100 | 100 | 100 | | | | | | 100 | |
| Photosensitive polyimide | | | | | | | 100 | | | | | | 100 |
| precursor (A-3) | | | | | | | | | | | | | |
| Condensate of 1,1,3-tris(2,5- | (parts) | 30 | 30 | | 30 | 30 | | 30 | 30 | 30 | 30 | 5 | |
| dimethyl-4-hydroxyphenyl)-3- | | | | | | | | | | | | | |
| phenylpropane (1 mole) and 1,2- | | | | | | | | | | | | | |
| naphthoquinoneazido-5-sulfonic | | | | | | | | | | | | | |
| acid chloride (2 moles) (B-1) | | | | | | | | | | | | | |
| Condensate of 4,4′-[1-[4-[1-(4- | (parts) | | | 30 | | | | | | | | | |
| hydroxyphenyl)-1-methylethyl] | | | | | | | | | | | | | |
| phenyl]ethylidene]bisphenol | | | | | | | | | | | | | |
| and 1,2-naphthoquinone diazide-5- | | | | | | | | | | | | | |
| sulfonic acid chloride (B-2) | | | | | | | | | | | | | |
| Condensate of 2,3,4,4′- | (parts) | | | | | | | | | | | | |
| tetrahydroxybenzophenone | | | | | | | | | | | | | |
| and 1,2-naphthoquinoneazido- | | | | | | | | | | | | | |
| 5-sulfonic acid chloride (B-3) | | | | | | | | | | | | | |
| Triethyleneglycol diacrylate (B-4) | (parts) | | | | | | 28 | | | | | | 28 |
| N-phenylglycidine (B-5) | (parts) | | | | | | 2 | | | | | | 2 |
| 3,3′,4,4′-tetra(t-butylperoxycarbonyl) | (parts) | | | | | | 2 | | | | | | 2 |
| benzophenone (B-6) | | | | | | | | | | | | | |
| Silane-modified epoxy resin (C-1) | (parts) | 10 | 10 | 10 | | 10 | 10 | 0.05 | 200 | 10 | 10 | 1 | 10 |
| Silane-modified phyenol resin (C-2) | (parts) | | | | 10 | | | | | | | | |
| Silane-modified polyamic acid (C-3) | (parts) | | | | | | | | | | | | |
| Silane-modified acrylic resin (C-4) | (parts) | | | | | | | | | | | | |
| Pentaerythritol tetrakis | (parts) | 2 | 2 | 2 | 2 | | 2 | 2 | 2 | 0.05 | 15 | 2 | 15 |
| [3-(3′,5′-di-tert-buty1-4′- | | | | | | | | | | | | | |
| hydroxyphenyl)propionate] (D-1) | | | | | | | | | | | | | |
| 6-(4-hydroxy-3,5-di-t-butylanilino)-2, | (parts) | | | | | 2 | | | | | | | |
| 4-bis-ocryithio-1,3,5-triazine (D-2) | | | | | | | | | | | | | |
| Tris(nonylphenyl)phosphite (D-3) | (parts) | | | | | | | | | | | | |
| 3,4-epoxycyclohexenylmethyl-3′,4′- | (parts) | | 30 | 30 | 30 | 30 | 30 | 30 | 30 | 30 | 30 | 30 | 30 |
| epoxycyclohexenecarboxylate (E-1 ) | | | | | | | | | | | | | |
| 1,2-epoxy-4-(2-oxiranyl)cyclohexane | (parts) | 30 | | | | | | | | | | | |
| adduct of 2,2-bis(hydroxymethyl)- | | | | | | | | | | | | | |
| 1-butanol (E-2) | | | | | | | | | | | | | |
| 1,2,4-benzenetricarboxylic acid | (parts) | 3 | 3 | 3 | 3 | 3 | 3 | 3 | 3 | 3 | 3 | 3 | 3 |

Evaluation

| | | | | | | | | | | | | |
|---|---|---|---|---|---|---|---|---|---|---|---|---|
| Amount of warping of resin film | Good | Good | Good | Good | Good | Good | Poor | Good | Good | Good | Poor | Poor |
| Surface conditions of resin film | Good | Good | Good | Good | Good | Good | Good | Poor | Good | Good | Poor | Poor |
| Flatness | Good | Good | Good | Good | Good | Good | Good | Poor | Good | Good | Good | Good |
| Light resistance | Good | Good | Good | Good | Good | Good | Good | Good | Poor | Poor | Poor | Poor |
| Heat resistance | Good | Good | Good | Good | Good | Good | Poor | Good | Poor | Poor | Poor | Poor |

As shown in Tables 1 and 2, a resin composition comprised that a radiation-sensitive compound (B), predetermined amount of silane-modified resin (C), and predetermined amount of antioxidant (D) were added to the binder resin (A), and where an amount of warping was controlled to be in a range of 14 μm or less when made into a resin film gave a resin film which had good surface conditions, high flatness, and excellent light resistance and heat resistance (Examples 1 to 19).

On the other hand, if the silane-modified resin (C) is too small in parts by weight, the amount of warping after baking when made into a resin film becomes larger and the obtained resin film becomes inferior in heat resistance (Comparative Example 1).

Further, if the silane-modified resin (C) is too large in parts by weight, the obtained resin film becomes inferior in surface conditions and further becomes insufficient in flatness (Comparative Example 2).

Furthermore, if the antioxidant (D) is too small in parts by weight or too large, the obtained resin film becomes inferior in light resistance and heat resistance as a result (Comparative Examples 3, 4).

Furthermore, even if blending a radiation-sensitive compound (B), predetermined amount of silane-modified resin (C), and predetermined amount of antioxidant (D) into the binder resin (A), in the case that the amount of warping after baking when made into a resin film exceeds 14 μm, the obtained resin film was inferior in the surface conditions of the resin film, light resistance, and heat resistance (Comparative Examples 5, 6).

1-7. (canceled)

8. A resin composition containing a binder resin (A), radiation-sensitive compound (B), silane-modified resin (C), and antioxidant (D), wherein a content of the silane-modified resin (C) is 0.1 to 150 parts by weight with respect to 100 parts by weight of the binder resin (A), a content of the antioxidant (D) is 0.1 to 10 parts by weight with respect to 100 parts by weight of the binder resin (A), and an amount of warping is 14 μm or less when using the resin composition to form a thickness 2 to 3 μm resin film and baking the formed resin film at 230° C.

9. The resin composition as set forth in claim 8,
wherein the content of the radiation-sensitive compound (B) is 20 to 100 parts by weight with respect to 100 parts by weight of the binder resin (A).

10. The resin composition as set forth in claim 8, wherein the silane-modified resin (C) is a compound obtained by chemically bonding at least one polymer material selected from a polyester, polyamide, polyimide, polyamic acid, epoxy resin, acrylic resin, urethane resin, and phenol resin, and a silicon compound.

11. The resin composition as set forth in claim 10,
wherein the silicon compound is a silicon compound expressed by the following formula and/or a partially hydrolyzed condensate of a silicon compound expressed by the following formula,
(R⁸)ᵣ—Si—(OR⁹)₄₋ᵣ
(in the above formula, r is an integer of 0 to 3, R⁸ is a C₁ to C₁₀ alkyl group which may have a functional group which is directly bonded to a carbon atom, a C₆ to C₂₀ aryl group, or C₂ to C₁₀ unsaturated aliphatic group, wherein when R⁸ is a plurality of groups, the plurality of R³ may be the same or different, R⁹ is a hydrogen atom or C₁ to C₁₀ alkyl group which may have a functional group which is directly bonded to a carbon atom, wherein when R⁹ is a plurality of groups, the plurality of R⁹ may be the same or different.)

12. The resin composition as set forth in claim 8, wherein the binder resin (A) is a cyclic olefin polymer having a protonic polar group, acrylic resin, or polyimide.

13. The resin composition as set forth in claim 8, further contains a cross-linking agent (E).

14. A semiconductor device board having a resin film comprised of the resin composition of claim 8.

15. A curable resin composition comprised of an alicyclic olefin polymer (A) having polar groups, a curing agent (B), a hindered phenol compound (C), and a hindered amine compound (D).

16. The curable resin composition as set forth in claim 15, wherein the polar groups of said alicyclic olefin polymer (A) are of at least one type selected from the group comprised of a carboxyl group, carboxylic acid anhydride group, and phenolic hydroxyl group.

17. The curable resin composition as set forth in claim 16, wherein said curing agent (B) is a compound which has two or more functional groups in its molecule.

18. The curable resin composition as set forth in claim 15, wherein a ratio of said hindered phenol compound (C) and said hindered amine compound (D) is, in weight ratio of the compound (C)/compound (D), 1/0.05 to 1/25.

19. A shaped article obtained by forming the curable resin composition as set forth in claim 15 into a sheet shape or a film shape.

20. A cured article obtained by curing the curable resin composition as set forth in claim 15.

21. A cured article obtained by curing the sheet-shaped or film-shaped shaped article as set forth in claim 19.

22. A surface treated cured article obtained by roughening the surface of the cured article as set forth in claim 20 by an aqueous solution of a permanganate, then electrolessly plating the roughened surface.

23. A laminate obtained by laminating a board which has a conductor layer on its surface and the cured article as set forth in claim 22.

24. A multilayer circuit board obtained by further forming a conductor layer on the layer comprised of the cured article or surface treated cured article of the laminate as set forth in claim 23.

25. An electronic device which is provided with the multilayer circuit board as set forth in claim 24.

26. A laminate obtained by laminating a board which has a conductor layer on its surface and the surface treated cured article as set forth in claim 22.
